(19) United States
(12) Patent Application Publication
(10) Pub. No.: US 2007/0223953 A1
(43) Pub. Date: Sep. 27, 2007

(54) FIXING APPARATUS, IMAGE FORMING APPARATUS INCLUDING SAME FIXING APPARATUS, METHOD FOR CONTROLLING FIXING APPARATUS, PROGRAM FOR CONTROLLING FIXING APPARATUS, COMPUTER-READABLE RECORDING MEDIUM

(76) Inventors: Toshiaki KAGAWA, Kitakatsuragi-gun (JP); Tomohiro MAEDA, Osaka (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/687,680

(22) Filed: Mar. 19, 2007

(30) Foreign Application Priority Data
Mar. 24, 2006 (JP) 2006-84206

(51) Int. Cl. G03G 15/20

(52) U.S. Cl. 399/69; 399/70

(57) ABSTRACT

An image forming apparatus includes a control circuit for controlling amounts of heat transfer of a fixing roller and a pressure roller such that (Q1−Q0)/Hc≦11 (more preferably, ≦0) is satisfied where Q0 represents total amounts (J) of heat that the fixing roller and the pressure roller have during standby or just after completion of warm-up, Q1 represents total amounts (J) of heat that the fixing roller and the pressure roller have and that are saturated as a result of continuously fixing unfixed images onto recording materials and the heat amounts that the fixing roller and the pressure roller have are saturated, and Hc represents a heat capacity (J/° C.) of the fixing roller and the pressure roller.

This Nonprovisional application claims priority under 35 U.S.C. § 119(a) on Patent Application No. 2006-084206 filed in Japan on Mar. 24, 2006, the entire contents of which are hereby incorporated by reference.

### FIELD OF THE INVENTION

The present invention relates to (i) a fixing apparatus used in an electrophotographic image forming apparatus, and (ii) a fixing method. Further, the present invention relates to an image forming apparatus including the fixing apparatus.

### BACKGROUND OF THE INVENTION

A specific example of a general fixing apparatus having been conventionally and frequently used in an electrophotographic image forming apparatus such as a copying machine and a printer is a fixing apparatus having a pair of rollers (fixing roller and pressure roller), which serve as fixing members and are pressed against each other. Heating means such as a halogen heater is provided inside each of the rollers or inside one of the rollers, so as to heat the rollers up to a predetermined temperature (fixing temperature). After the heating, a recording sheet on which an unfixed image is formed passes through a pressing section (fixing nip area) formed between the rollers, with the result that the toner image is fixed thereon by heat and pressure. In other word, such a fixing apparatus adopts a heating roller fixing method.

More specifically, a general fixing apparatus for fixing a monochrome image (hereinafter, referred to as “monochrome use fixing apparatus”) includes (i) a fixing roller including a metal core whose surface is coated with a fluorine-based resin or the like, and (ii) a pressure roller including a metal core having a surface on which an elastic layer made of a silicone rubber or the like is provided. The fixing roller is heated by a heating source (heating means), such as a halogen heater, provided inside the fixing roller. Such a monochrome use fixing apparatus is disclosed in, e.g., Patent Citation 1 (Japanese Unexamined Patent Publication Tokukaisho 63-149684/1988 (published on Jun. 22, 1988) and Patent Citation 2 (Japanese Unexamined Patent Publication Tokukaihei 3-89383 (published on Apr. 15, 1991).

On the other hand, a general fixing apparatus for fixing a color image (hereinafter, referred to as “color use fixing apparatus”) uses, as a fixing roller, an elastic roller having a surface on which an elastic layer made of a silicone rubber or the like is provided. Moreover, heating sources (heating means) such as halogen heaters are provided not only in the fixing roller but also in a pressure roller. Such a color use fixing apparatus is disclosed in, e.g., Patent Citation 3 Japanese Unexamined Patent Publication Tokukaihei 11-143277 (published on May 11, 1999).

The color use fixing apparatus is configured in this way for the following benefits. When such an elastic fixing roller is pressed against the recording sheet, the surface of the fixing roller is deformed with its elasticity so as to correspond to unevenness of the unfixed toner image, thus covering the surface on which the toner image is formed. This makes it possible to uniformly heat and fix a color toner image, whose toner amount is larger than that of a monochrome toner image and is varied according to colors used therein. In addition to the uniform heating and fixation, there is another benefit. That is, strain release effect allowed by the elastic layer in the fixing nip area improves a releasing property with respect to the color toner image, which is offset more easily as compared with a monochrome toner image.

Further, the fixing nip area has such a nip shape that projects upward (so-called “reverse nip shape”), so that the recording sheet is detached therefrom more easily. That is, the recording sheet can be detached therefrom with no assistance from a detaching means such as a detaching nail (self-strip). This prevents image defects caused by the detaching means. Meanwhile, the color toner image requires a larger amount of toner as compared with the monochrome toner image and needs to be sufficiently vivid, so that a larger amount of heat needs to be applied to the color toner image than that to the monochrome toner image. For this reason, the heating sources are provided not only in the fixing roller but also in the pressure roller.

On the other hand, the fixing roller of the monochrome use fixing apparatus does not require any elastic layer. Therefore, in order to secure a sufficient fixing nip width, it is necessary that the elastic layer of the pressure roller is thicker than that of the pressure roller of the color use fixing apparatus. Therefore, even if a heating source is provided in the pressure roller, efficiency of heat conduction to the surface of the pressure roller is bad because the pressure roller is provided with such a thick elastic layer made of silicone rubber much inferior to a metal in terms of thermal conductivity. As such, there is little effect exhibited by providing the heating source therein. Further, if the heating source is provided in the pressure roller, the heating source not only exhibits little good effect but also causes the following problems: (i) warm-up time becomes longer; (ii) a temperature of an interface between the elastic layer and the metal core becomes so high that the elastic layer comes off from the metal core; and the like. For these reasons, it is not general to provide a heating source in the pressure roller of the monochrome use fixing apparatus.

The pressure roller of the conventional monochrome use fixing apparatus has no heating source as described above, so that the temperature of the pressure roller is increased by heat conducted from the fixing roller. While the fixing apparatus is in a standby state, the fixing roller and the pressure roller are usually not rotated, so that only the section (fixing nip area) at which the pressure roller and the fixing roller are pressed against each other is heated. Further, the surface of the pressure roller is heated; however, the heat is not sufficiently conducted to the inside of the pressure roller and to a portion away from the fixing nip area, due to the elastic layer having the low heat conduction efficiency and provided therebetween. As a result, the temperature of the pressure roller is not increased sufficiently.

When the conventional monochrome use fixing apparatus is brought from such a standby state to a fixing operation state, the fixing roller and the pressure roller are kept on being pressed against each other but are driven to rotate. Accordingly, the pressure roller draws heat from the fixing roller drastically. This heat conduction from the fixing roller to the pressure roller continues until the temperature of the pressure roller (inclusive of the inside of the pressure roller) is completely saturated. Therefore, more electric power is required during the period of time until the temperature is saturated, as compared with electric power required after the temperature of the pressure roller is saturated. The extra electric power thus required is the largest just after the start of the fixing operation. For example, in the case of a monochrome use fast image forming apparatus carrying out image forming with respect to 80 sheets per minute or faster, extra electric power of 250 W or more is required momentarily.

On the other hand, the fixing roller and the pressure roller of the conventional color use fixing apparatus include the heating sources respectively, so that the rollers are evenly heated in their circumferential directions by the heating sources therein while the conventional color use fixing apparatus is in the standby state. Further, heat lost during the standby is only heat radiated from the surfaces of the fixing roller and the pressure roller. Therefore, even though the elastic layers each having the low thermal conductivity are provided on the surfaces of the fixing roller and the pressure roller, there occurs no large temperature difference in the thickness directions of the rollers (the roller internal temperature≈the roller external temperature). However, once the color use fixing apparatus is brought from the standby state to the fixing operation state, recording sheets and toner drastically draw heat from the fixing roller and the pressure roller via the fixing nip area. In order to maintain the surface temperatures of the fixing roller and the pressure roller, a large temperature gradient (the roller internal temperature>the roller external temperature) needs to be made. The temperature inside each of the rollers is kept on being increased until the temperature of the roller is completely saturated. Therefore, more electric power is required while the temperature of the inside of the roller is increased, as compared with electric power required after the temperature of the roller is saturated. The extra electric power thus required is the largest just after the start of the fixing operation. For example, in the case of a color use fast image forming apparatus carrying out image forming with respect to 70 sheets per minute or faster, extra electric power of 1000 W or greater is required momentarily.

### SUMMARY OF THE INVENTION

Generally, a printer or a copying machine for office use is designed such that electric consumption therein is, e.g., equal to or smaller than 1.5 kVA (1500 W). Therefore, electric power usable for a fixing apparatus used in the printer or the copying machine is limited to, e.g., 900 W or so. In the conventional monochrome use fixing apparatus, it is necessary to take into consideration the heat (250 W at maximum) accumulated in the pressure roller. Likewise, in the conventional color use fixing apparatus, it is necessary to take into consideration the heat (1000 W at maximum) accumulated in the fixing roller and the pressure roller. Thus, the maximum electric power used during the fixing operation exceeds 900 W. This is a problematic in accelerating processing speed.

The present invention is made in view of the foregoing conventional problems, and its major object is to provide (i) a fixing apparatus in which the maximum electric power consumption during its operation is small and which allows acceleration of processing speed; (ii) an image forming apparatus including the fixing apparatus, (iii) a method for controlling the fixing apparatus; (iv) a program for controlling the fixing apparatus; and (v) a computer-readable recording medium.

To achieve the object, a fixing apparatus according to the present invention includes: a plurality of fixing members for heating and pressing an unfixed image, formed on a recording material, by sandwiching and transporting the recording material; and control means for controlling amounts of heat transfer of the fixing members such that Formula (1), (Q1−Q0)/Hc≦11, is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

To achieve the object, it is more preferable to arrange the fixing apparatus according to the present invention such that: the control means controls the amounts of the heat transfer of the fixing members such that Formula (2), Q1−Q0/Hc≦0, is satisfied.

According to the above structure, the amounts of the heat transfer of the fixing members are restrained such that Formula (1) is satisfied. More preferably, the heat transfer therein is restrained such that Formula (2) is satisfied.

In each of the conventional color use fixing apparatus and the conventional monochrome use fixing apparatus, (Q1−Q0)/Hc≦0 is satisfied, i.e., heat is accumulated in the plurality of fixing members. For example, in the color use fixing apparatus, the rubber roller inferior in terms of thermal conductivity is used as a fixing member, and is heated from inside. Therefore, during passage of sheets, the temperature of the metal core of the rubber roller becomes higher than the temperature that the metal core has during the standby, with the result that Q1>Q0 is satisfied. In the meanwhile, in the monochrome use fixing apparatus, no heating source is provided in the fixing member that makes contact with a recording material so as to meet a surface on which no image is formed, so that the fixing member making contact with the recording sheet so as to meet the surface on which no image is formed is not heated almost at all during the standby. However, during the passage of sheets, each of the sheets draws heat from the fixing member that makes contact with the recording material so as to meet the surface on which an image is formed, with the result that heat is accumulated inside the fixing member. Accordingly, Q1>Q0 is satisfied. As a result of such accumulation of heat, the maximum value of the electric power consumed during the passage of sheets is large. In such a conventional fixing apparatus, the electric power consumption is likely to be increased by 200 W to 1000 W or greater momentarily. The increase of the electric power consumption due to the accumulation of heat is a big problem in attaining restraint of electric power consumption down to 1.5 kW or smaller in a color copying machine (color image forming apparatus) or a fast copying machine (image forming apparatus capable of fast processing), each of which uses the fixing apparatus and consumes electric power a lot.

However, in the fixing apparatus of the present invention, the amounts of the heat transfer of the fixing members is controlled such that Formula (1) is satisfied, so that the amount of heat accumulated in the fixing members is equal to or smaller than 11×Hc. More preferably, the amounts of the heat transfer of the fixing members is controlled such that Formula (2) is satisfied, so that the amount of heat accumulated in the fixing members is 0 or a negative value.

In this way, electric power is saved (by 1000 W or greater at maximum) as compared with the conventional fixing apparatus. This makes it possible that electric power of 1.5 kW is used in an image forming apparatus using the fixing apparatus. Examples of the image forming apparatus using the fixing apparatus include a color fast copying machine or a super fast copying machine.

As described above, the fixing apparatus of the present invention allows realization of a fixing apparatus in which the maximum electric power consumption during operation is small and which allows acceleration of processing speed.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a diagram schematically illustrating a structure of a fixing apparatus according to one embodiment of the present invention.

FIG. 2 is a diagram schematically illustrating a fixing apparatus according to another embodiment of the present invention.

FIG. 3 is a diagram schematically illustrating a fixing apparatus according to one comparative example to the present invention.

FIG. 4 is a diagram illustrating changes of electric power consumptions of the fixing apparatuses shown in FIG. 1, FIG. 2, and FIG. 3, respectively.

FIG. 5(a) is a diagram illustrating changes of temperatures of component members of the fixing apparatuses shown in FIG. 1.

FIG. 5(b) is a diagram illustrating changes of temperatures of component members of the fixing apparatuses shown in FIG. 2.

FIG. 5(c) is a diagram illustrating changes of temperatures of component members of the fixing apparatuses shown in FIG. 3.

FIG. 6(a) is a diagram illustrating (i) temperature distributions that the components of the fixing apparatus shown in FIG. 1 have in the circumferential direction of the pressure roller just before passage of sheets and (ii) temperature distributions that the components thereof have in the circumferential direction just after the passage of sheets.

FIG. 6(b) is a diagram illustrating (i) temperature distributions that the components of the fixing apparatus shown in FIG. 2 have in the circumferential direction of the pressure roller just before passage of sheets and (ii) temperature distributions that the components thereof have in the circumferential direction just after the passage of sheets.

FIG. 6(c) is a diagram illustrating (i) temperature distributions that the components of the fixing apparatus shown in FIG. 3 have in the circumferential direction of the pressure roller just before passage of sheets and (ii) temperature distributions that the components thereof have in the circumferential direction just after the passage of sheets.

FIG. 7 is a diagram illustrating an amount of heat accumulated in each fixing member per unit of time during operation of each of the fixing apparatuses shown in FIG. 1, FIG. 2, and FIG. 3.

FIG. 8 is a diagram illustrating (i) a relation between an average increased temperature and the maximum electric power consumption in cases where controlled temperature of the pressure roller shown in FIG. 1 is changed during standby, and (ii) a relation between (a) the average increased temperature and (b) a difference between a temperature of the pressure roller at the beginning of the operation and a temperature of the pressure roller after the end of the operation.

FIG. 9 is a diagram schematically illustrating a fixing apparatus according to still another embodiment of the present invention.

FIG. 10 is a diagram schematically illustrating a fixing apparatus according to yet another embodiment of the present invention.

FIG. 11 is a diagram schematically illustrating a fixing apparatus according to another comparative example to the present invention.

FIG. 12(a) is a diagram illustrating changes of electric power consumption of each of the fixing apparatuses shown in FIGS. 9 and 11.

FIG. 12(b) is a diagram illustrating changes of electric power consumption of each of the fixing apparatuses shown in FIGS. 10 and 11.

FIG. 13(a) is a diagram illustrating changes of temperatures of component members of the fixing apparatus shown in FIG. 9.

FIG. 13(b) is a diagram illustrating changes of temperatures of component members of the fixing apparatus shown in FIG. 10.

FIG. 13(c) is a diagram illustrating changes of temperatures of component members of the fixing apparatus shown in FIG. 11.

FIG. 14(a) is a diagram illustrating an amount of heat accumulated in each fixing member per unit of time during operation of each of the fixing apparatuses shown in FIG. 9 and FIG. 11.

FIG. 14(b) is a diagram illustrating an amount of heat accumulated in each fixing member per unit of time during operation of each of the fixing apparatuses shown in FIG. 10 and FIG. 11.

FIG. 15 is a diagram illustrating (i) a relation between an average increased temperature and the maximum electric power consumption in cases where controlled temperature of the pressure roller of the fixing apparatus shown in FIG. 9 is changed during standby, and (ii) a relation between (a) the average increased temperature and (b) a difference between a temperature of the pressure roller at the beginning of the operation and a temperature of the pressure roller after the end of the operation.

FIG. 16 is a diagram schematically illustrating an image forming apparatus according to one embodiment of the present invention.

FIG. 17 is a diagram schematically illustrating an image forming apparatus according to another embodiment of the present invention.

### DESCRIPTION OF THE EMBODIMENTS

### Embodiments 1: Monochrome Use Fixing Apparatus

### Embodiment 1-1

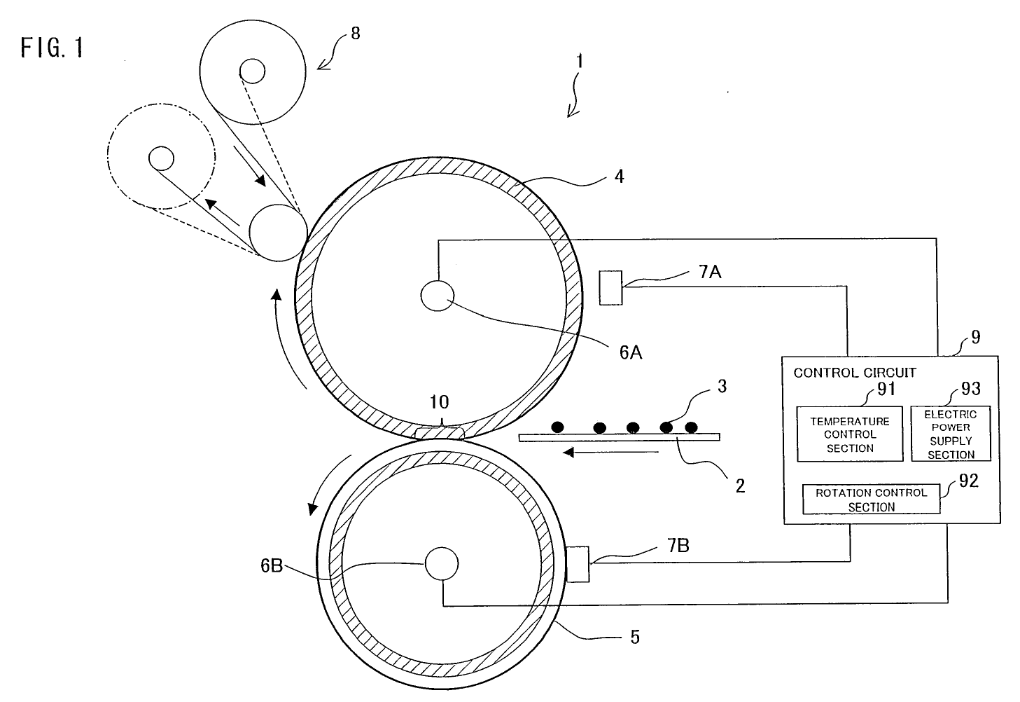

The following explains a fixing apparatus 1 according to Embodiment 1-1 of the present invention, with reference to FIG. 1. The fixing apparatus 1 according to the present embodiment heats and presses an unfixed toner image formed on a surface of a recording sheet (recording material) 2, so as to fix the toner image onto the recording sheet 2. The unfixed toner image is formed by a developer 3 (hereinafter, also referred to as “toner”). Examples of the developer 3 include a nonmagnetic mono-component developer (nonmagnetic toner), a nonmagnetic two-component developer (nonmagnetic toner and carrier), a magnetic developer (magnetic toner), and the like.

FIG. 1 is a cross sectional diagram illustrating a structure of the fixing apparatus 1 according to the present embodiment. As shown in FIG. 1, the fixing apparatus 1 includes: (i) a fixing roller (fixing member) 4; (ii) a pressure roller (fixing member) 5; (iii) a heater lamp 6A serving as a heating source for heating the fixing roller 4; (iv) a heater lamp 6B serving as a heating source for heating the pressure roller 5; (v) thermistors 7A and 7B used as temperature sensors for detecting temperatures of the fixing roller 4 and the pressure roller 5, respectively; (vi) a web cleaning device 8 for cleaning the fixing roller 4; and (vii) a control circuit (control means) 9 for controlling overall operations of the fixing apparatus 1. In the present embodiment, the fixing roller 4 and the pressure roller 5 serve as fixing members. Further, in the present embodiment, each of the heater lamps 6A and 6B serves as the heating means. The control circuit 9 includes (i) a temperature control section 91 for controlling the heating means so as to control set temperature of each of the fixing members (fixing roller and pressure roller); (ii) a rotation control section 92 for controlling rotation timing of each of the fixing members; and (iii) an electric power supply section 93 for controlling a ratio of electric power to be supplied to the heating means for heating the fixing member.

The fixing roller 4 is heated to have a predetermined temperature (175° C. here; however, the temperature is not limited to 175° C.). The fixing roller 4 thus heated heats the recording sheet 2 on which the unfixed toner image is formed, when the recording sheet 2 passes through a fixing nip area 10 of the fixing apparatus 1. So, the heater lamp 6A, which heats the fixing roller 4, is provided inside the fixing roller 4. The heater lamp 6A emits light and radiates infrared rays in response to electrification from the electric power supply section 93 to the heater lamp 6A. The infrared rays are absorbed in the internal circumferential surface of the fixing roller 4, and the internal circumferential surface is therefore heated, with the result that the fixing roller 4 is entirely heated.

The fixing roller 4 herein has a diameter of 70 mm; however, the diameter is not limited to 70 mm. The fixing roller 4 has a two-layer structure in which a releasing layer and a metal core are provided in this order from the inside. Suitably used for the metal core is (i) a metal such as iron, stainless steel, aluminum, or copper; (ii) an alloy of them; or the like. In the present embodiment, the metal core is made of aluminum and has a thickness of 4 mm. Suitable for the releasing layer is a fluorine-based material such as (i) PFA (copolymer of tetrafluoroethylene and perfluoroalkylvinylether) or (ii) PTFE (polytetrafluoroethylene). In the present embodiment, the releasing layer is formed by PFA coating so as to have a thickness of 25 μm.

Together with the fixing roller 4, the pressure roller 5 presses the recording sheet 2 on which the unfixed toner image is formed, as described below. Provided inside the pressure roller 5 is the heater lamp 6B. The heater lamp 6B emits light and radiates infrared rays in response to electrification from the electric power supply section 90 to the heater lamp 6B. The infrared rays thus radiated are absorbed in the internal surface of the pressure roller 5, and the internal surface is therefore heated, with the result that the pressure roller 5 is entirely heated.

In the pressure roller 5, an elastic layer made of silicone rubber or the like is provided on a surface of a metal core made of a metal such as iron steel, stainless steel, or aluminum, and a releasing layer made of PFA or the like is provided on the elastic layer. Specifically, in the pressure roller 5 of the present embodiment, the metal core is made of iron and has a thickness of 2 mm, and the elastic layer provided on the surface of the metal core is a silicone rubber layer and has a thickness of 3 mm. Such an elastic layer is coated with a PFA tube serving as the releasing layer and having a thickness of 50 μm.

Provided face to face with the circumferential surfaces of the fixing roller 4 and the pressure roller 5 are the thermistors 7A and 7B each used as temperature detecting means so as to detect the surface temperatures of the rollers, respectively. Specifically, the thermistor 7A is a non-contact type thermistor for detecting the temperature of the fixing roller 4, whereas the thermistor 7B is a contact-type thermistor for detecting the temperature of the pressure roller. In accordance with data of the temperatures detected by the thermistors 7A and 7B, the temperature control section 91 serving as the temperature control means controls electrification to the heater lamps 6A and 6B such that each of the rollers has the predetermined temperature.

The fixing roller 4 and the pressure roller 5 are pressed against each other by a predetermined load (600 N in the present embodiment but the load is not limited to 600 N), thereby forming the fixing nip area 10 therebetween. The fixing nip area 10 is a section at which the fixing roller 4 and the pressure roller 5 are pressed against each other. The width thereof in the circumferential direction is 8 mm herein; however, the width is not limited to this value. The recording sheet 2 passes through such a fixing nip area 10, with the result that the toner image is fixed thereonto. When the recording sheet 2 passes through the fixing nip area 10, the fixing roller 4 makes contact with the recording sheet 2 so as to meet the surface on which the toner image is formed, and the pressure roller 5 makes contact with the recording sheet 2 so as to meet the surface opposite to the surface on which the toner image is formed.

In the fixing nip area 10, the recording sheet 2 on which the unfixed toner image is formed is transferred at a predetermined fixing speed and a predetermined copying speed, and the unfixed toner image is fixed thereonto by heat and pressure. The “fixing speed” refers to a so-called “processing speed” and is 400 mm/sec herein. The “copying speed” refers to how many sheets are copied per minute, and is 85 sheets/minute herein.

Note that the fixing apparatus 1 is provided with a driving motor (driving means; not shown) for driving and rotating the fixing roller 4 in accordance with control of the rotation control section 92 such that the recording sheet 2 passes through the fixing nip area 10. Further, the pressure roller 5 is rotated according to the rotation of the fixing roller 4. As shown in FIG. 1, the fixing roller 4 and the pressure roller 5 are rotated in directions reverse to each other.

### Embodiment 1-2

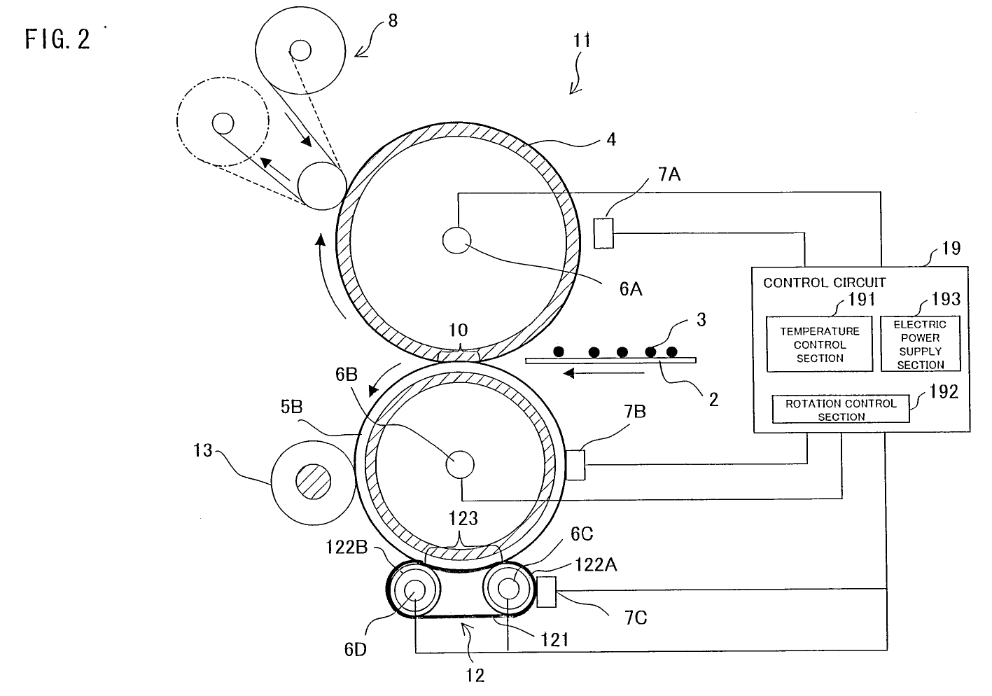

The following fully explains a structure of a fixing apparatus 11 of Embodiment 1-2 of the present invention, with reference to FIG. 2. As shown in FIG. 2, the structure of the fixing apparatus 11 of Embodiment 1-2 is identical to the structure of the fixing apparatus 1 of Embodiment 1-1, except that an external heating unit 12 and a cleaning roller 13 for cleaning the pressure roller 5 are provided in contact with the pressure roller 5. For this reason, component members identical to those in FIG. 1 are given the same reference numerals, and explanation thereof will be omitted. Also in the present embodiment, the fixing roller 4 and the pressure roller 5 serve as the fixing members. Further, the heating means is made up of heater lamps 6A, 6B, 6C, and 6D (or heater lamps 6A and 6B and external heating unit 12). The control circuit 19 includes a temperature control section 191, a rotation control section 192, and an electric power supply section 193. In addition to the processes carried out by the temperature control section 91, the temperature control section 191 controls the heater lamps 6C and 6D in accordance with data of temperature detected by a thermistor 7C as described later.

The external heating unit 12 includes an external heating belt 121, heating rollers 122A and 122B, heater lamps 6C and 6D, and the thermistor 7C. The external heating belt 121 has a diameter of 30 mm, is heated to have a predetermined temperature (here, 140° C.), and is in contact with the surface of the pressure roller 5 so as to heat the surface of the pressure roller 5. The external heating belt 121 is set around the two heating rollers 122A and 122B, each of which has a diameter of 15 mm.

Provided inside the heating rollers 122A and 122B are the heater lamps 6C and 6D for heating the heating rollers 122A and 122B, respectively. Each of the heater lamps 6C and 6D emits light and radiates infrared rays in response to electrification from the electric power supply section 193 to each of the heater lamps 6C and 6D, with the result that the internal circumferential surfaces of the heating rollers 122A and 122B are heated. Via the heating rollers 122A and 122B, the external heating belt 121 is heated indirectly.

The external heating belt 121 is provided to meet the pressure roller 5 in a side opposite to the side in which the fixing nip area 10 is formed, within a cross sectional surface taken along a line perpendicular to the rotation axis of the pressure roller 5. During standby, the external heating belt 121 is separated from the pressure roller 5. During operation, the external heating belt 121 is pressed against the pressure roller 5 with a predetermined pressing force (here, 40N). Formed between the pressure roller 5 and the external heating belt 121 thus pressed against each other is a heating nip section 123 (here, 20 mm in the circumferential direction). Rotation of the pressure roller 5 causes rotation of the external heating belt 121. According to the rotation of the external heating belt 121, the heating rollers 122A and 122B are rotated.

The external heating belt 121 has, e.g., a two-layer structure in which a synthetic resin material (fluorine-based resin such as PFA or PTFE) excellent in heat resistance and releasing property is provided as a releasing layer on a surface of a base material made of either a heat resistant resin or a metal material and having a hollow cylindrical shape. A specific example of the heat resistant resin is polyimide, and examples of the metal material include stainless steel, nickel, and the like. In the present embodiment, the structure of the external heating belt 121 is as follows: the base material is made of polyimide and has a thickness of 90 Mm, and the releasing layer, provided on the surface of the base material, is made of a mixture of PFA and PTFE and has a thickness of 15 μm. For reduction of deviation force of the external heating belt 121, the internal surface of the belt base material may be coated with a fluorine-based resin or the like.

Each of the heating rollers 122A and 122B is made up of a metal core that is made of aluminum, an iron-based material, or the like and that has a hollow cylindrical shape. For reduction of deviation force of the external heating belt 121, the internal surface of the metal core may be coated with a fluorine-based resin or the like.

In the vicinity of the circumferential surfaces of the fixing roller 4, the pressure roller 5, and the external heating belt 121, the thermistors 7A, 7B, and 7C each serving as the temperature detecting means are provided so as to detect the surface temperatures of the fixing roller 4, the pressure roller 5, and the external heating belt 121, respectively. In accordance with the data of the temperatures respectively detected by the thermistors 7A, 7B, and 7C, the temperature control section 191 serving as the temperature control means controls electrification to the heater lamps 6A, 6B, 6C, and 6D such that the temperatures of the fixing roller 4, the pressure roller 5, and the external heating belt 121 have the predetermined temperatures, respectively.

Note that the fixing apparatus 11 is provided with a driving motor (driving means; not shown) for driving and rotating the fixing roller 4 under control of the rotation control section 192 such that the recording sheet 2 passes through the fixing nip area 10.

### EXAMPLE 1-1

In Example 1-1, electric power consumed during the operation of the fixing apparatus 1 having the structure explained in Embodiment 1-1 was actually measured. In Example 1-1, the measurement was carried out as follows: the fixing apparatus 1 was in the standby state for such a sufficiently long time (30 minutes in Example 1-1) that the respective temperatures of the component members of the fixing apparatus 1 were saturated, and then one thousand A4-sized sheets having a basic weight of 60 g were continuously supplied, and then electric power consumption and the temperature of each of the fixing members on this occasion were measured. Further, two-dimensional heat conduction simulation was carried out under the same conditions as those of this measurement. It was confirmed that the results of the actual measurement substantially coincide with the results of analysis of the simulation. Items that could not be measured in the actual measurement were found by the simulation.

Table 1 below illustrates measurement conditions in Example 1-1 (implementation conditions in the fixing apparatus 1). In Example 1-1, the heater lamp 6B of the pressure roller 5 was used (turned ON) only when the fixing apparatus 1 was in the standby state, and was not used (turned OFF) when the fixing apparatus 1 was in the operation state. The results of the measurement and of the simulation will be described later.

TABLE 1

| | | | | Operation |
|---|---|---|---|---|
| | | | | State |
| | | | Standby | (Passage |
| | | | State | of 1000 |
| | | | (30 min) | Sheets) |
| Example | Rated | Halogen | 800 W | 1100 W |
| 1-1 | Electric | Heater A | | |
| | Power | (Fixing) | | |
| | | Halogen | 300 W | — |
| | | Heater B | | |
| | | (Pressure) | | |
| | Controlled | Fixing | 175° C. | 175° C. |
| | Temperature | Roller | | |
| | | Pressure | 140° C. | — |
| | | Roller | | |
| Example | Rated | Halogen | 700 W | 1000 W |
| 1-2 | Electric | Heater A | | |
| | Power | (Fixing) | | |
| | | Halogen | 300 W | — |
| | | Heater B | | |
| | | (Pressure) | | |
| | | Halogen | 100 W | 100 W |
| | | Heaters C | | |
| | | and D | | |
| | | (External) | | |
| | Controlled | Fixing | 175° C. | 175° C. |
| | temperature | Roller | | |
| | | Pressure | 120° C. | — |
| | | Roller | | |
| | | External | 140° C. | 140° C. |
| | | Belt | | |
| Comparative | Rated | Halogen | 1300 W | 1300 W |
| Example 1 | Electric | Heater A | | |
| | Power | (Fixing) | | |
| | | Halogen | — | — |
| | | Heater B | | |
| | | (Pressure) | | |
| | Controlled | Fixing | 160° C. | 160° C. |
| | temperature | Roller | | |
| | | Pressure | — | — |
| | | Roller | | |

Note that: in Table 1, each heater lamp is described as “halogen heater”, and the external heating belt is described as “external belt”.

### EXAMPLE 1-2

In Example 1-2, electric power consumed during the operation of the fixing apparatus 11 explained in Embodiment 1-2 was actually measured. In Example 1-2, the measurement was carried out as follows: the fixing apparatus 11 was in the standby for such a sufficiently long time (30 minutes in Example 1-2) that the respective temperatures of the component members of the fixing apparatus 11 were saturated, and then one thousand A4-sized sheets having a basic weight of 60 g were continuously supplied, and then electric power consumption and the temperature of each of the fixing members on this occasion were measured. Further, two-dimensional heat conduction simulation was carried out under the same conditions as those of this measurement. It was confirmed that the results of the actual measurement substantially coincide with the results of analysis of the simulation. Items that could not be measured in the actual measurement were found by the simulation.

Table 1 above illustrates measurement conditions in Example 1-2 (implementation conditions in the fixing apparatus 11). In Example 1-2, the heater lamp 6B of the pressure roller 5 was used (turned ON) only when the fixing apparatus 11 was in the standby state, and was not used (turned OFF) when the fixing apparatus 11 was in the operation state. The results of the measurement and of the simulation will be described later.

### COMPARATIVE EXAMPLE 1

As a comparative example to Examples 1-1 and 1-2, in Comparative Example 1, electric power consumed during an operation of a monochrome use fixing apparatus whose pressure roller had no internal heating source as is the case with the conventional one was actually measured. In Comparative Example 1, the measurement was carried out as follows: the fixing apparatus was in the standby state for such a sufficiently long time (30 minutes in Example 1-2) that the respective temperatures of the component members of the fixing apparatus were saturated, and then one thousand A4-sized sheets having a basic weight of 60 g were continuously supplied, and then electric power consumption and the temperature of each of the fixing members on this occasion were measured. Further, two-dimensional heat conduction simulation was carried out under the same conditions as those of this measurement. It was confirmed that the results of the actual measurement substantially coincide with the results of analysis of the simulation. Items that could not be measured in the actual measurement were found by the simulation.

Table 1 above illustrates measurement conditions in Comparative Example 1. The results of the measurement and of the simulation will be described later.

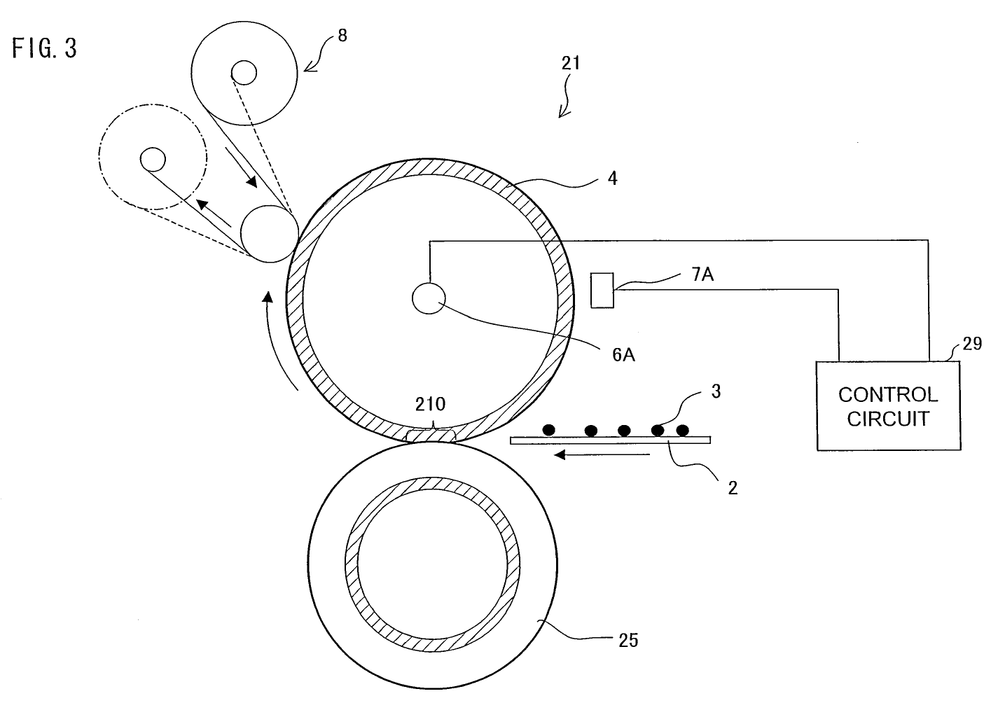

The fixing apparatus used as Comparative Example 1 is explained here with reference to FIG. 3. As shown in FIG. 3, the fixing apparatus 21 of Comparative Example 1 has an identical structure to that of the fixing apparatus 1 of Embodiment 1-1, apart from a pressure roller 25. Therefore, explanation for component members other than the pressure roller 25 is omitted, and the same component members as those of the fixing apparatus 1 will be given the same reference numerals. Note that no heater lamp and no thermistor are provided for the pressure roller 25 of the fixing apparatus 21 of Comparative Example 1. The control circuit 29 controls the heater lamp 6A in accordance with data of temperature detected by the thermistor 7A provided for the fixing roller 4.

The pressure roller 25 is arranged such that: an elastic layer such as a silicone rubber is provided on a surface of a metal core made of iron steel, stainless steel, aluminum, or the like, and a releasing layer such as PFA is provided on the elastic layer. Specifically, in the pressure roller 25 of Comparative Example 1, the metal core is made of iron and has a thickness of 3 mm, the elastic layer provided on the surface of the metal core is a silicone rubber layer and has a thickness of 9 mm, and the releasing layer coating the elastic layer is a PFA tube and has a thickness of 50 μm.

The fixing roller 4 and the pressure roller 25 are pressed against each other by a predetermined load (1400 N here but the load is not limited to 1400 N), thereby forming a fixing nip area 210 therebetween. The fixing nip area 210 is a section at which the fixing roller 4 and the pressure roller 25 are pressed against each other. The width thereof in the circumferential direction is 11 mm in this comparative example; however, the width is not limited to this value.

The thermistor 7A, which serves as the temperature detecting means, is provided face to face with the circumferential surface of the fixing roller 4 so as to detect the surface temperature of the fixing roller 4. Here, the thermistor 7A is a non-contact type thermistor. In accordance with data of temperature detected by the thermistor 7A, the control circuit 29, which serves as the temperature control means, controls electrification to the heater lamp 6A such that the surface temperature of the fixing roller 4 has a predetermined temperature.

(Study on Examples and Comparative Example: Monochrome Use Fixing Apparatus)

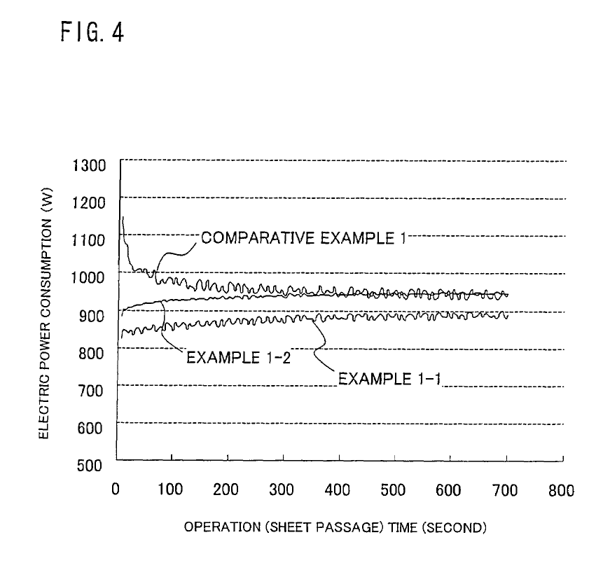

Explained next are the measurement (experiment) results and the simulation results of Example 1-1, Example 1-2, and Comparative Example 1, with reference to FIG. 4 to FIG. 8.

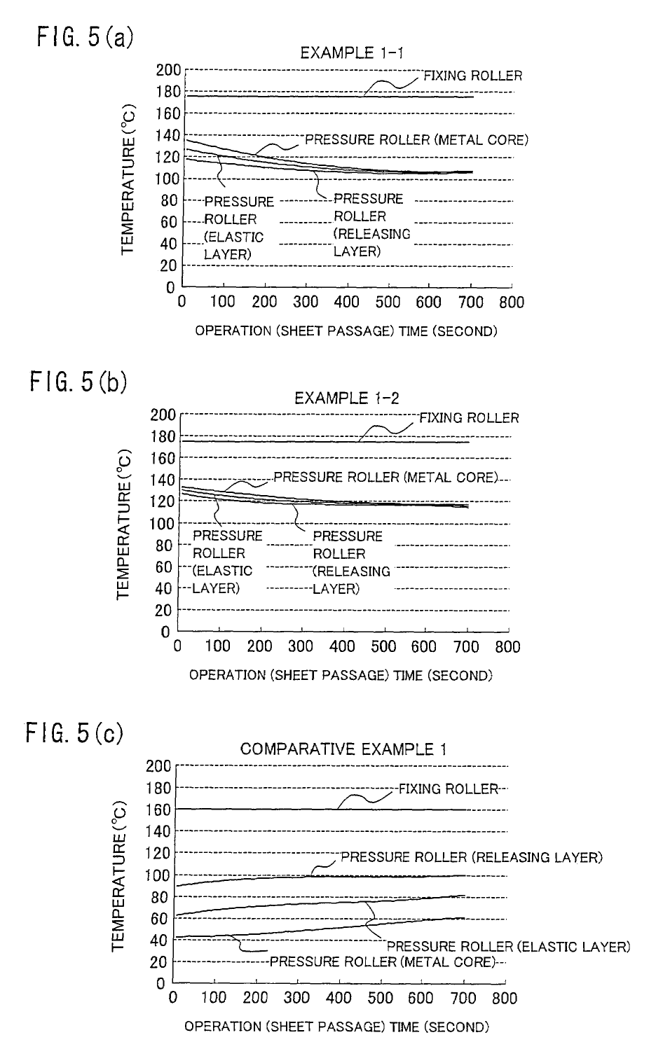

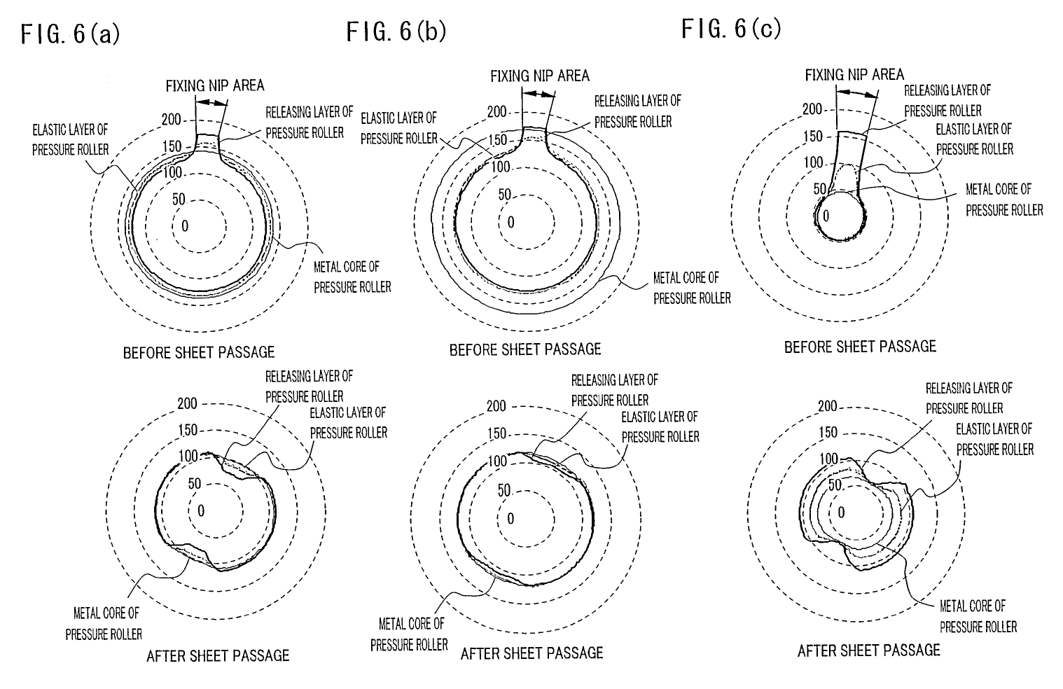

FIG. 4 is a graph (measurement results) illustrating respective changes of electric power consumptions in the fixing apparatuses of Example 1-1, Example 1-2, and Comparative Example 1. Each of FIG. 5(a) to FIG. 5(c) is a graph (simulation results) illustrating respective changes of the temperatures of the component members of each of the fixing apparatuses of Example 1-1, Example 1-2, and Comparative Example 1. Each of FIG. 6(a) to FIG. 6(c) is a graph (simulation results) illustrating (i) temperature distribution that each of the sections of the pressure roller had in the circumferential direction of the pressure roller just before the passage of the sheets, and (ii) temperature distribution that each of the sections had therein just after the end of the passage of the sheet.

According to FIG. 4, in Comparative Example 1, the maximum electric power required at the beginning of the sheet passage was 1148 W. In contrast, the maximum electric power required in Example 1-1 was 898 W and the maximum electric power required in Example 1-2 was 949 W. As such, the maximum electric power in each of Examples 1-1 and 1-2 was smaller by approximately 200 W to 250 W than that in Comparative Example 1.

Explained here is a reason why the maximum electric power consumption in each of Examples 1-1 and 1-2 was smaller than that in Comparative Example 1, with reference to FIG. 5 and FIG. 6. In the fixing apparatus of Comparative Example 1, a heated portion of the pressure roller in the standby state is only the portion (fixing nip area) making contact with the fixing roller, so that temperature is uneven in the circumferential direction of the pressure roller. Specifically, the temperature of the surface of the portion opposite to the fixing nip area is raised up to only approximately 45° C. Further, no heating source is provided inside the pressure roller of the fixing apparatus of Comparative Example 1, so that temperature is also uneven in the thickness direction of the pressure roller. Specifically, even the temperature of the metal core of the pressure roller just below the fixing nip area is raised up to approximately 45° C. Accordingly, once the fixing apparatus of Comparative Example 1 is brought into the operation state, heat is drawn rapidly from the fixing roller. After the end of the operation, the temperatures of the surface and the inside of the pressure roller are greatly raised as compared with those in the standby state (heat is accumulated in the pressure roller).

In contrast, in each of Examples 1-1 and 1-2, the pressure roller is heated by the heater lamp, which is an internal heating source, in the standby state, so that the pressure roller is evenly heated entirely. Therefore, while the fixing apparatus is in the operation state, the amount of heat conducted from the fixing roller to the pressure roller is substantially equal to the amount of heat consumed by the fixation of toner, heat radiation, and the like.

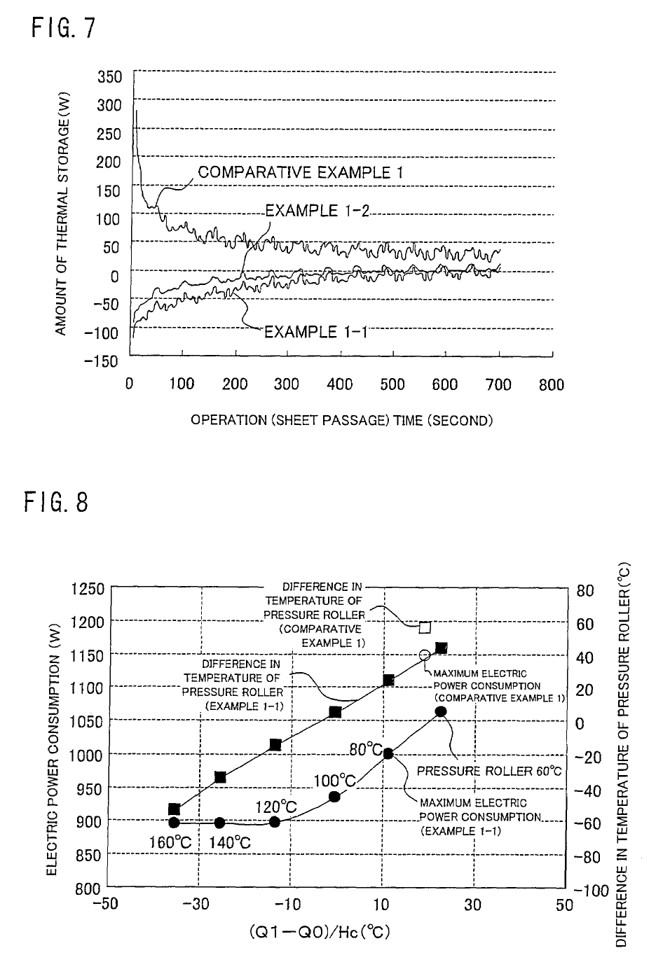

FIG. 7 illustrates results of simulation of finding the amount (amount of thermal storage; thermal storage amount) of heat accumulated in each of the fixing members (fixing roller and pressure roller) per unit of time during the operation state. In FIG. 7, the thermal storage amount is “+” when heat is accumulated in the fixing member, whereas the thermal storage amount is “−” when heat is radiated therefrom. As apparent from the results, in Comparative Example 1, heat was rapidly accumulated in the fixing member at the beginning of the operation state. On the other hand, in each of Examples 1-1 and 1-2, heat was slightly radiated at the beginning of the operation state and then the thermal storage amount became stable around 0.

Here, the fixing roller is mostly constituted by the aluminum metal core material having a high thermal conductivity, so that there is substantially no unevenness in temperature over the fixing roller. So, when the controlled temperature is unvarying, it is possible to assume that the amount of heat accumulated therein is substantially unvarying. Thus, it is possible to say that the pressure roller is totally responsible for the fluctuation in the amount of heat accumulated in the fixing members. In other words, the pressure roller draws heat from the fixing roller, thereby fluctuating the thermal storage amount.

Table 2 shows results of calculating how much the thermal storage amount was increased during the operation. This increment of the thermal storage amount (hereinafter, referred to as “heat accumulation increment”) is found as follows: Q1−Q0, where Q0 represents the amount (J) of heat accumulated in the fixing members in the initial state of the fixing apparatus (upon the start of the operation), and Q1 represents the amount (J) of heat accumulated therein when the operation is ended. Here, Q1 is a total amount (J) of heat after saturation of the thermal storage amount. That is, if the thermal storage amount has been saturated at the end of the operation, the total of the amount of heat at the moment is equal to Q1 (J). If the thermal storage amount is not saturated at the end of operation, the total of the amount of heat at the moment is not equal to Q1 (J). In each of the above cases, the thermal storage amount had been saturated at the end of the operation, so that the total of the amount of heat was equal to Q1 (J). Further, each of Q0 and Q1 is a total amount of heat that the fixing members have. In cases where the fixing members are made up of the fixing roller and the pressure roller, each of Q0 and Q1 is a sum of the amounts of heat that the fixing roller and the pressure roller have.

TABLE 2

| | | | (Q1 − Q0)/Hc |
|---|---|---|---|
| | Q1 − Q0 (J) | Hc (J/° C.) | (° C.) |
| Example 1-1 | −17423 | 1298 | −13.4 |
| Example 1-2 | −7414 | 1298 | −5.7 |
| Comparative | 35588 | 1855 | 19.2 |
| Example 1 | | | |

According to Table 2, the thermal storage amount was increased in Comparative Example 1, whereas the thermal storage amount was slightly decreased in each of Examples 1-1 and 1-2. Now, the respective heat accumulation increments Q1−Q0 in the fixing apparatuses having different structures from one another are compared in accordance with a value ((Q1−Q0)/Hc)) obtained by dividing the heat accumulation increment Q1−Q0 by Hc (J/° C.), which represents the heat capacity of the fixing members (fixing roller and pressure roller here) of each fixing apparatus.

Here, the heat capacity Hc is found by addition of the heat capacities of the component members (fixing roller and pressure roller) constituting the fixing members. In cases where the fixing roller is made up of component members A, B, and C respectively having heat capacities HcA, HcB, and HcC, the fixing roller has a heat capacity Hcf=HcA+HcB+HcC. Likewise, in cases where the pressure roller is made up of component members D, E, and F respectively having heat capacities HcD, HcE, and HcF, the pressure roller has a heat capacity Hcp=HcD+HcE+HcF. Accordingly, the heat capacity Hc of the fixing members is found as follows: Hc=Hcf+Hcp.

Table 2 above shows the value (Q1−Q0)/Hc in each of Example 1-1, Example 1-2, and Comparative Example 1. This value (Q1−Q0)/Hc represents a temperature by which the temperature of the fixing member is increased in average due to the thermal storage amount increased during the operation, and is therefore hereinafter referred to as “average increased temperature”.

### EXAMPLE 1-3

Next, the fixing apparatus 1 used in Example 1-1, which is the actually manufactured fixing apparatus 1 of Embodiment 1, was used in a study for finding (a) a relation between the average increased temperature and the maximum electric power consumption; and (b) a relation between (i) the average increased temperature and (ii) a difference between the temperature that the pressure roller had at the beginning of the operation and the temperature that the pressure roller had at the end of the operation. The study was conducted under such conditions that the controlled temperature of the pressure roller was changed during the standby in a range from 60° C. to 160° C. Note that the value of each temperature difference was positive when the temperature of the pressure roller was high at the end of the operation, whereas the value thereof was negative when the temperature thereof was low at the end of the operation. Results of this study are shown in FIG. 8. FIG. 8 also illustrates (a) a relation between the average increased temperature and the maximum electric power consumption in the fixing apparatus of Comparative Example 1; and (b) a relation between (i) the average increased temperature and (ii) a difference between the temperature that the pressure roller of the fixing apparatus of Comparative Example 1 had at the beginning of the operation and the temperature that the pressure roller thereof had at the end of the operation. The temperature of the pressure roller of the fixing apparatus of Comparative Example 1 was not controlled, so that FIG. 8 illustrates one point for each of the relations in the case of Comparative Example 1.

According to FIG. 8, the smaller the average increased temperature (Q1−Q0)/Hc was, the better the maximum electric power consumption was restrained. It was found that when (Q1−Q0)/Hc≦11 was satisfied, the maximum electric power consumption was reduced as compared with that of the conventional case (Comparative Example 1). Further, it was found that when (Q1−Q0)/Hc≦0 (or Q1−Q0≦0) was satisfied, the maximum electric power consumption was minimal. Therefore, it is more preferable that (Q1−Q0)/Hc≦0 be satisfied.

In the meanwhile, it was found that: as the average increased temperature (Q1−Q0)/Hc became smaller below 0, the absolute value of the temperature difference in the pressure roller was larger, i.e., the temperature that the pressure roller had at the end of the operation was too much lower than the temperature that the pressure roller had at the beginning of the operation. Moreover, great change in the temperature of the pressure roller causes change of a fixing property (fix level) of toner. In consideration of this, (Q1−Q0)/Hc≧−13 is sufficient in restraining the maximum electric power consumption and securing a stable fixing property.

Further, as apparent from comparison between FIG. 5(a) and FIG. 5(b), in cases where the external heating means is provided for the pressure roller as is the case with Example 1-2, the change in the temperature of the pressure roller can be restrained, with the result that the fixing property of toner is stabilized.

### Embodiments 2: Color Use Fixing Apparatus

### Embodiment 2-1

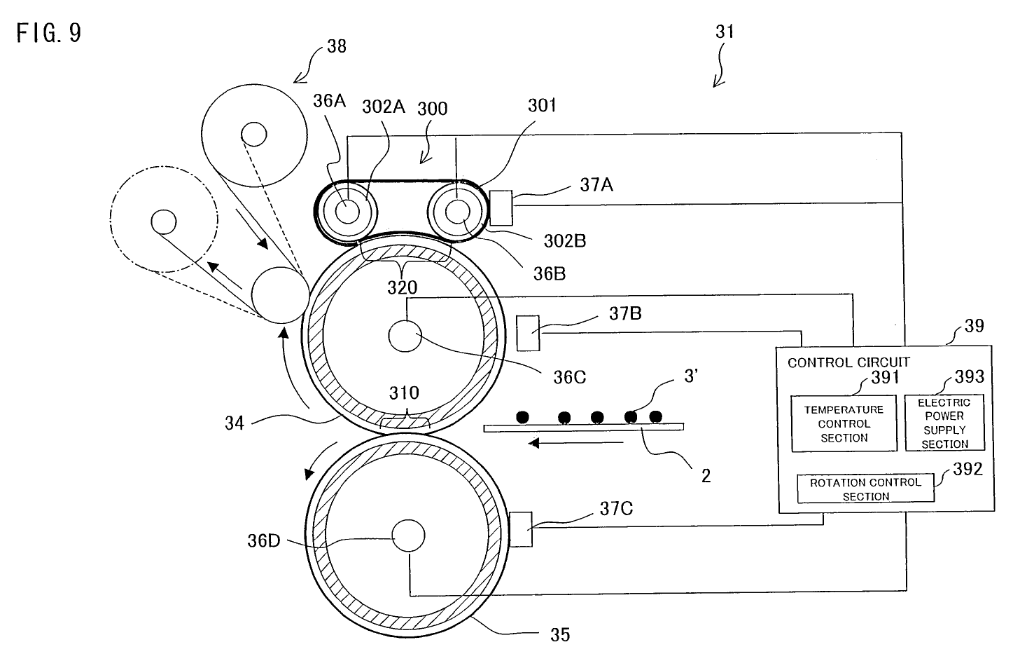

The following explains a fixing apparatus 31 according to Embodiment 2-1 of the present invention, with reference to FIG. 9. The fixing apparatus 31 according to the present embodiment heats and presses an unfixed color toner image formed on a surface of a recording sheet (recording material) 2, so as to fix the color toner image onto the recording sheet 2. The unfixed color toner image is formed by a developer 3′ (hereinafter, also referred to as “toner”). Examples of the developer 3′ include a nonmagnetic mono-component developer (nonmagnetic toner), a nonmagnetic two-component developer (nonmagnetic toner and carrier), a magnetic developer (magnetic toner), and the like.

FIG. 9 is a cross sectional diagram illustrating a structure of the fixing apparatus 31 according to the present embodiment. As shown in FIG. 9, the fixing apparatus 31 according to the present embodiment includes: (i) a fixing roller (fixing member) 34; (ii) a pressure roller (fixing member) 35; (iii) an external heating unit 300; (iv) a heater lamp 36C serving as a heating source for heating the fixing roller 34; (v) a heater lamp 36D serving as a heating source for heating the pressure roller 35; (vi) thermistors 37A, 37B, and 37C used as temperature sensors for detecting temperatures of the external heating unit 300, the fixing roller 34, and the pressure roller 35, respectively; and (vii) a web cleaning device 38 for cleaning the fixing roller 34. The fixing apparatus 31 further includes a control circuit (control means) 39 for controlling overall operations of the fixing apparatus 31. In the present embodiment, the fixing roller 34 and the pressure roller 35 serve as fixing members. Further, in the present embodiment, the heating means is made up of heater lamps 36A, 36B, 36C, and 36D (or the external heating unit 300 and the heater lamps 36C and 36D). The control circuit 39 includes (i) a temperature control section 391 for controlling the heating means so as to control set temperatures of the fixing members (fixing roller and pressure roller); (ii) a rotation control section 392 for controlling rotation timing of each of the fixing members; and (iii) an electric power supply section 393 for controlling a ratio of electric power to be supplied to the heating means for heating the fixing members.

The external heating unit 300 includes: (i) an external heating belt 301; (ii) heating rollers 302A and 302B for heating the external heating belt 301 set around the heating rollers 302A and 302B; and (iii) the heater lamps 36A and 36B serving as the heating sources for heating the heating rollers 302A and 302B.

The fixing roller 34 is heated to have a predetermined temperature (180° C. here; however, the temperature is not limited to 180° C.). The fixing roller 34 thus heated heats the recording sheet 2 on which the unfixed toner image is formed, when the recording sheet 2 passes through a fixing nip area 310 of the fixing apparatus 31. The fixing roller 34 herein has a diameter of 50 mm. The fixing roller 4 has a three-layer structure in which a metal core, an elastic layer, and a releasing layer are provided in this order from inside. Used for the metal core is, e.g., (i) a metal such as iron, stainless steel, aluminum, or copper; (ii) an alloy of them; or the like. In the present embodiment, the metal core is made of aluminum and has a thickness of 3 mm. Suitably used for the elastic layer is a silicone rubber. Suitably used for the releasing layer is a fluorine-based material such as (i) PFA (copolymer of tetrafluoroethylene and perfluoroalkylvinylether) or (ii) PTFE (polytetrafluoroethylene). In the present embodiment, the elastic layer is made of a silicone rubber and has a thickness of 2 mm, and the releasing layer is formed by PFA tube and has a thickness of 30 μm.

Provided inside the fixing roller 34 is the heater lamp 36C for heating the fixing roller 34. In response to electrification from the electric power supply section 393 to the heater lamp 36C, the heater lamp 36C emits light and radiates infrared rays. The infrared rays thus radiated are absorbed in the internal circumferential surface of the fixing roller 34 and the internal circumferential surface is therefore heated, with the result that the fixing roller 34 is heated entirely.

Together with the fixing roller 34, the pressure roller 35 presses the recording sheet 2 on which the unfixed toner image is formed, as described below. As is the case with the fixing roller 34, the pressure roller 35 in the present embodiment has a diameter of 50 mm, and has a metal core and an elastic layer provided on the circumferential surface of the metal core. The metal core is made of aluminum and has a thickness of 3 mm, and the elastic layer is made of silicone rubber and has a thickness of 2 mm. Provided on the elastic layer is a releasing layer made of a PFA tube and having a thickness of 30 μm.

Provided inside the pressure roller 35 is the heater lamp 36D for heating the pressure roller 35. In response to electrification from the electric power supply section 393 to the heater lamp 36D, the heater lamp 36D emits light and radiates infrared rays. The infrared rays thus radiated are absorbed in the internal circumferential surface of the pressure roller 35, and the internal circumferential surface is therefore heated, with the result that the pressure roller 35 is entirely heated.

The fixing roller 34 and the pressure roller 35 are pressed against each other by a predetermined load (600 N in the present embodiment but the load is not limited to 600 N), thereby forming the fixing nip area 310 therebetween. The fixing nip area 310 is a section at which the fixing roller 34 and the pressure roller 35 are pressed against each other. The width thereof in the circumferential direction is 9 mm herein; however, the width is not limited to this value. The recording sheet 2 passes through such a fixing nip area 310, with the result that the color toner image is fixed thereonto. When the recording sheet 2 passes through the fixing nip area 310, the fixing roller 34 makes contact with the recording sheet 2 so as to meet the surface on which the toner image is formed, and the pressure roller 35 makes contact with the recording sheet 2 so as to meet the surface opposite to the surface on which the toner image is formed.

The external heating belt 301 herein has a diameter of 30 mm, is heated to have a predetermined temperature (here, 220° C.), and makes contact with the surface of the fixing roller 34 so as to heat the surface of the fixing roller 34. The external heating belt 301 is set around the two heating rollers 302A and 302B each having a diameter of 15 mm herein. Provided inside the heating rollers 302A and 302B are the heater lamps 36A and 36 B serving as heating sources for heating the heating rollers 302A and 302B, respectively. In response to electrification from the electric power supply section 393 to the heater lamps 36A and 36B, the heater lamps 36A and 36B emit light and radiate infrared rays. The infrared rays thus radiated heat the internal circumferential surfaces of the heating rollers 302 and 302B, thereby indirectly heating the external heating belt 301 via the heating rollers 302A and 302B.

The external heating unit 300 is provided to meet the fixing roller 34 in a side opposite to the side in which the fixing nip area 310 is formed, within a cross sectional surface taken along a line perpendicular to the rotation axis of the fixing roller 34. During standby, the external heating unit 300 is separated from the fixing roller 34. During operation, the external heating unit 300 is pressed against the fixing roller 34 with a predetermined pressing force (here, 40N). Formed between the fixing roller 34 and the external heating unit 300 thus pressed against each other is a heating nip section 320 (here, 20 mm in the circumferential direction). Rotation of the fixing roller 34 causes rotation of the external heating belt 301. According to the rotation of the external heating belt 301, the heating rollers 302A and 302B are rotated.

The external heating belt 301 has, e.g., a two-layer structure in which a synthetic resin material (fluorine-based resin such as PFA or PTFE) excellent in heat resistance and releasing property is provided as a releasing layer on a surface of a base material made of either a heat resistant resin or a metal material and having a hollow cylindrical shape. A specific example of the heat resistant resin is polyimide, and examples of the metal material include stainless steel, nickel, and the like. In the present embodiment, the structure of the external heating belt 301 is as follows: the base material is made of polyimide and has a thickness of 90 μm, and the releasing layer, provided on the surface of the base material, is made of a mixture of PFA and PTFE and has a thickness of 15 μm. For reduction of deviation force of the external heating belt 301, the internal surface of the belt base material may be coated with a fluorine-based resin or the like.

Each of the heating rollers 302A and 302B is made up of a metal core that is made of aluminum, an iron-based material, or the like and that has a hollow cylindrical shape. For reduction of deviation force of the external heating belt 301, the surface of the metal core may be coated with a fluorine-based resin or the like.

In the vicinity of the circumferential surfaces of the external heating unit 300, the fixing roller 34, and the pressure roller 35, the thermistors 37A, 37B, and 37C each serving as the temperature detecting means are provided so as to detect the surface temperatures of the external heating unit 300, the fixing roller 34, and the pressure roller 35, respectively. In accordance with the data of the temperatures respectively detected by the thermistors 37A, 37B, and 37C, the temperature control section 391 serving as the temperature control means controls electrification to the heater lamps 36A, 36B, 36C, and 36D such that the temperatures of the external heating unit 300, the fixing roller 34, and the pressure roller 35 have the predetermined temperatures, respectively.

In the fixing nip area 310, the recording sheet 2 on which the unfixed toner image is formed is transferred at a predetermined fixing speed and a predetermined copying speed, and the unfixed toner image is fixed thereonto by heat and pressure. The “fixing speed” refers to a so-called “processing speed” and is 355 mm/sec herein. The “copying speed” refers to how many sheets are copied per minute, and is 70 sheets/minute herein.

Note that the fixing apparatus 31 is provided with a driving motor (driving means; not shown) for driving and rotating the fixing roller 34 under control of the rotation control section 392 such that the recording sheet 2 passes through the fixing nip area 310. Further, the pressure roller 35 is rotated according to rotation of the fixing roller 34. The fixing roller 34 and the pressure roller 35 are rotated in direction opposite to each other as shown in FIG. 9.

### Embodiment 2-2

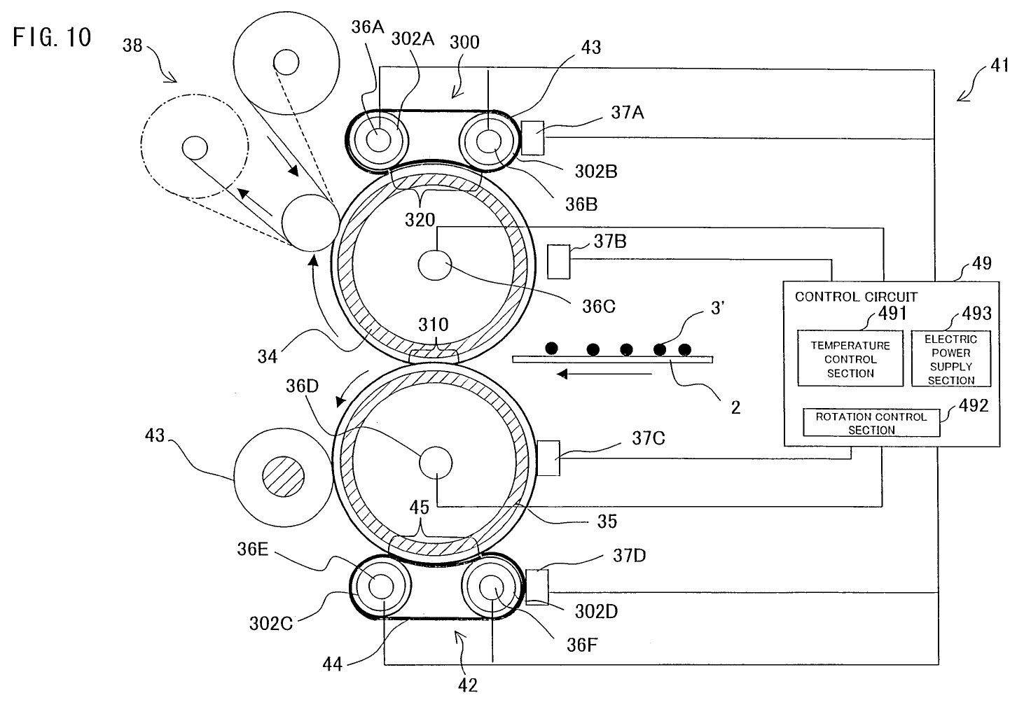

The following fully explains a structure of a fixing apparatus according to Embodiment 2-2 of the present invention, with reference to FIG. 10. As shown in FIG. 10, the structure of the fixing apparatus 41 of Embodiment 2-2 is identical to the structure of the fixing apparatus 31 of Embodiment 2-1, except that an external heating unit 42 and a cleaning roller 43 for cleaning the pressure roller 35 are provided in contact with the pressure roller 35. For this reason, component members identical to those in FIG. 9 are given the same reference numerals, and explanation thereof will be omitted. Also in the present embodiment, the fixing roller 34 and the pressure roller 35 serve as the fixing members. Further, in the present embodiment, the heating means is made up of heater lamps 36A, 36B, 36C, 36D, 36E, and 36F (or external heating unit 300, heater lamps 36C and 36D, and external heating unit 42). The control circuit 49 includes a temperature control section 491, a rotation control section 492, and an electric power supply section 493 for controlling a ratio of electric power to be supplied to the heating means for heating the fixing members. In addition to the processes carried out by the temperature control section 391, the temperature control section 491 controls the heater lamps 36E and 36F in accordance with data of temperature detected by a thermistor 37D.

The external heating unit 42 has an identical structure to the external heating unit 300. The external heating unit 42 includes: (i) an external heating belt 44; (ii) heating rollers 302C and 302D around which the external heating belt 44 is set and which heats the external heating belt 44; and (iii) the heater lamps 36E and 36F serving as heating sources for heating the heating rollers 302C and 302D respectively. These component members are respectively made of the same materials as the materials of which the corresponding component members of the external heating unit 300 are made, and have respectively the same shapes as those of the corresponding component members thereof. The external heating unit 42 is provided to meet the pressure roller 35 in a side opposite to the side in which the fixing nip area 310 is formed, within a cross sectional surface taken along a line perpendicular to the rotation axis of the pressure roller 35. During standby, the external heating unit 42 is separated from the pressure roller 35. During operation, the external heating unit 42 is pressed against the pressure roller 35 with a predetermined pressing force (here, 40N). Formed between the pressure roller 35 and the external heating unit 42 thus pressed against each other is a heating nip section 45 (here, 20 mm in the circumferential direction).

Note that the fixing apparatus 41 is provided with a driving motor (driving means; not shown) for driving and rotating the fixing roller 34 under control of the rotation control section 492 such that the recording sheet 2 passes through the fixing nip area 310.

### EXAMPLE 2-1

In Example 2-1, electric power consumed during the operation of the fixing apparatus 31 having the structure explained in Embodiment 2-1 was actually measured. In Example 2-1, the measurement was carried out as follows: the fixing apparatus 31 was in the standby state for such a sufficiently long time (30 minutes in Example 2-1) that the respective temperatures of the component members of the fixing apparatus 31 were saturated, and then one thousand A4-sized sheets having a basic weight of 60 g were continuously supplied, and then electric power consumption and the temperature of each of the fixing members on this occasion was measured. Further, two-dimensional heat conduction simulation was carried out under the same conditions as those of this measurement. It was confirmed that the results of the actual measurement substantially coincide with the results of analysis of the simulation. Items that could not be measured in the actual measurement were found by the simulation.

Table 3 below illustrates measurement conditions in Example 2-1 (implementation conditions in the fixing apparatus 31). The results of the measurement and of the simulation will be described later.

TABLE 3

| | | | | Operation |
|---|---|---|---|---|
| | | | | State |
| | | | Standby | (Passage |
| | | | State | of 1000 |
| | | | (30 min) | sheets) |
| Example | Rated | Halogen Heaters | 150 W | 800 W |
| 2-1 | Electric | A and B | | |
| | Power | (External) | | |
| | | Halogen Heater | 400 W | 50 W |
| | | C (Fixing) | | |
| | | Halogen Heater | 200 W | 100 W |
| | | D (Pressure) | | |
| | Controlled | External Belt | 220° C. | 220° C. |
| | Temperature | Fixing Roller | 180° C. | 180° C. |
| | | Pressure Roller | 140° C. | 140° C. |
| Example | Rated | Halogen Heaters | 150 W | 800 W |
| 2-2 | Electric | A and B | | |
| | Power | (Upper/External) | | |
| | | Halogen Heater | 400 W | — |
| | | C (Fixing) | | |
| | | Halogen Heater | 200 W | — |
| | | D (Pressure) | | |
| | | Halogen Heaters | 100 W | 150 W |
| | | E and F | | |
| | | (Lower/External) | | |
| | Controlled | External | 220° C. | 220° C. |
| | Temperature | Belt/Upper | | |
| | | Fixing Roller | 175° C. | — |
| | | Pressure Roller | 140° C. | — |
| | | External | 160° C. | 160° C. |
| | | Belt/Lower | | |
| Comparative | Rated | Halogen Heater | 1500 W | 1500 W |
| Example 2 | Electric | A (Fixing) | | |
| | Power | Halogen Heater | 500 W | 500 W |
| | | B (Pressure) | | |
| | Controlled | Fixing Roller | 175° C. | 175° C. |
| | Temperature | Pressure Roller | 140° C. | 140° C. |

Note that: in Table 3, each heater lamp is described as “halogen heater”, and each external heating belt is described as “external belt”.

### EXAMPLE 2-2

In Example 2-2, electric power consumed during the operation of the fixing apparatus 41 having the structure explained in Embodiment 2-2 was actually measured. In Example 2-2, the measurement was carried out as follows: the fixing apparatus 41 was in the standby state for such a sufficiently long time (30 minutes in Example 2-2) that the respective temperatures of the component members of the fixing apparatus 41 were saturated, and then one thousand A4-sized sheets having a basic weight of 60 g were continuously supplied, and then electric power consumption and the temperature of each of the fixing members on this occasion were measured. Further, two-dimensional heat conduction simulation was carried out under the same conditions as those of this measurement. It was confirmed that the results of the actual measurement substantially coincide with the results of analysis of the simulation. Items that could not be measured in the actual measurement were found by the simulation.

Table 3 above illustrates measurement conditions in Example 2-2 (implementation conditions in the fixing apparatus 41). In Example 2-2, the heater lamps of the fixing roller and the pressure roller were used (turned ON) only when the fixing apparatus 41 was in the standby state, and were not used (turned OFF) when the fixing apparatus 41 was in the operation state. The results of the measurement and of the simulation will be described later.

### COMPARATIVE EXAMPLE 2

As a comparative example to Examples 2-1 and 2-2, in Comparative Example 2, electric power consumed during an operation of a color use fixing apparatus having no external heating means as is the case with the conventional one was actually measured. In Comparative Example 2, the measurement was carried out as follows: the fixing apparatus was in the standby state for such a sufficiently long time (30 minutes in Comparative Example 2) that the respective temperatures of the component members of the fixing apparatus were saturated, and then one thousand A4-sized sheets having a basic weight of 60 g were continuously supplied, and then electric power consumption and the temperature of each of the fixing members on this occasion was measured. Further, two-dimensional heat conduction simulation was carried out under the same conditions as those of this measurement. It was confirmed that the results of the actual measurement substantially coincide with the results of analysis of the simulation. Items that could not be measured in the actual measurement were found by the simulation.

Table 3 above illustrates measurement conditions in Comparative Example 2. The results of the measurement and of the simulation will be described later.

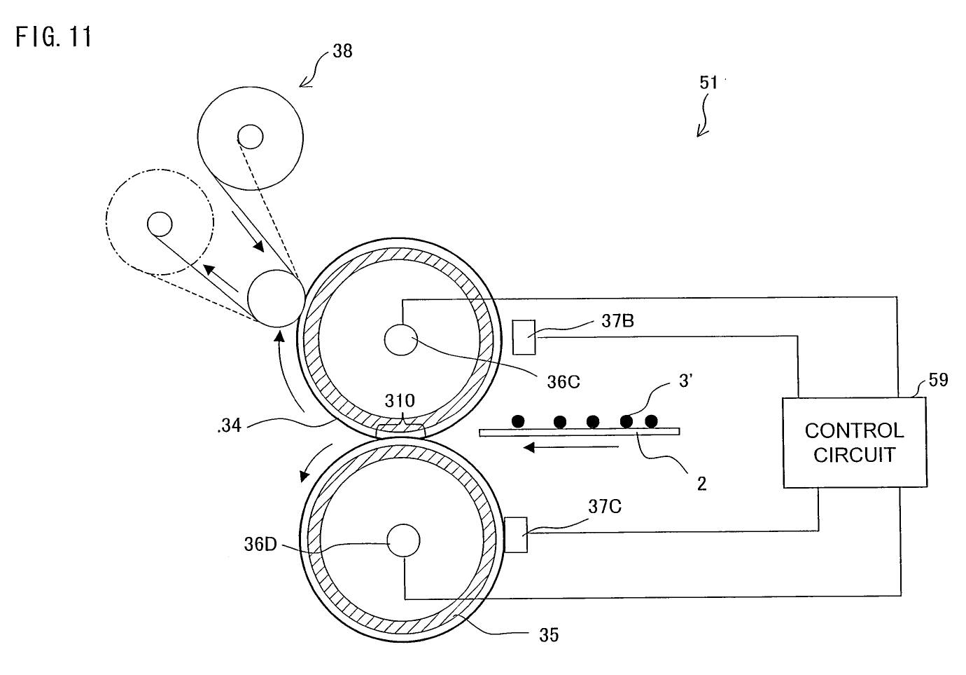

The fixing apparatus used as Comparative Example 2 is explained here with reference to FIG. 11. As shown in FIG. 11, the fixing apparatus 51 of Comparative Example 2 has an identical structure to that of the fixing apparatus 31 of Embodiment 2-1, except that the fixing apparatus 51 of Comparative Example 2 is not provided with the external heating unit 300. Therefore, explanation for the component members is omitted, and the same component members as those of the fixing apparatus 31 will be given the same reference numerals. Because no external heating unit 300 is provided in the fixing apparatus 51 of Comparative Example 2, the control circuit 59 does not carry out temperature control with respect to the external heating unit 300.

(Study on Examples and Comparative Example: Color Use Fixing Apparatus)

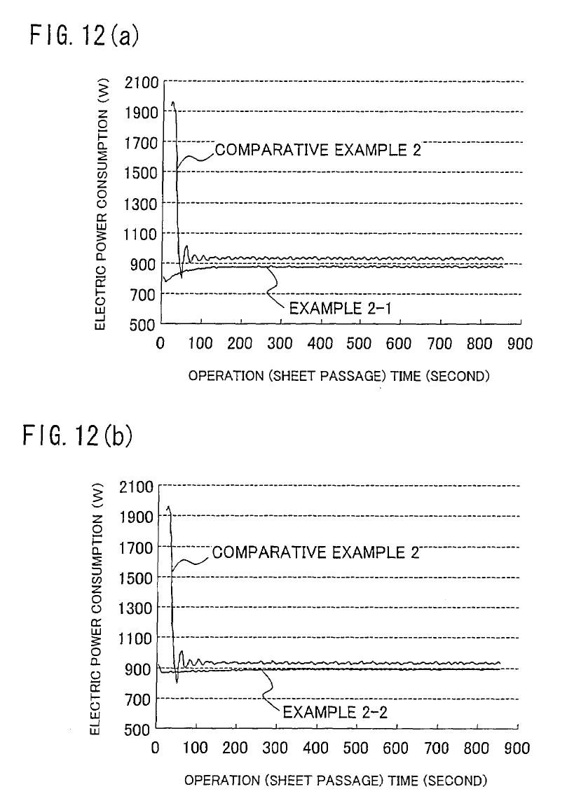

Explained next are the measurement (experiment) results and the simulation results of Example 2-1, Example 2-2, and Comparative Example 2, with reference to FIG. 12 to FIG. 14.

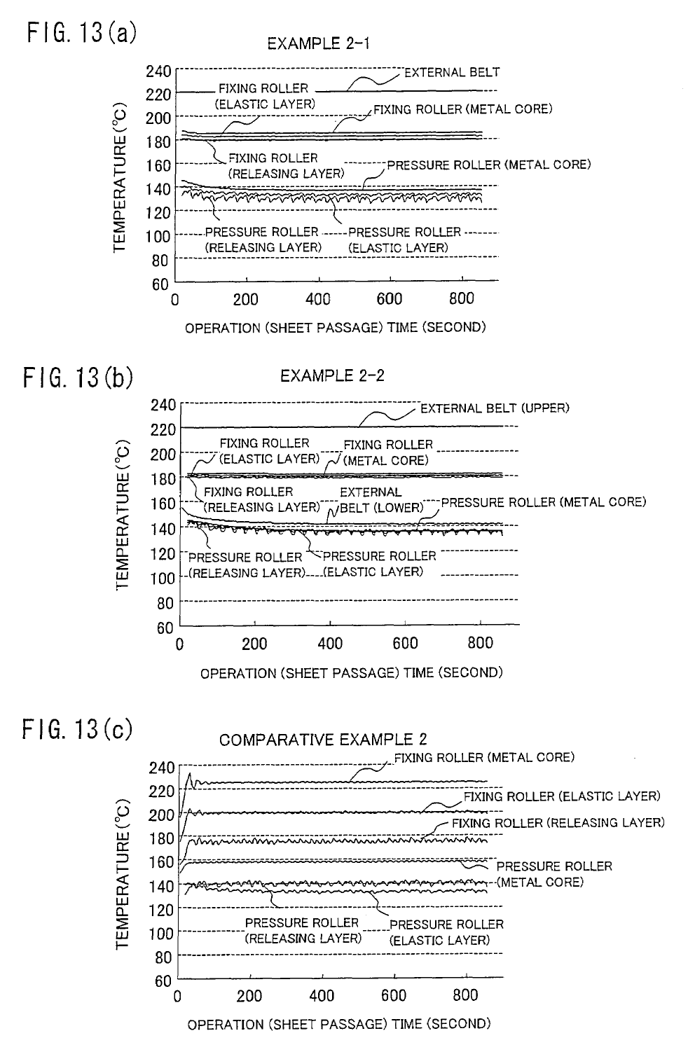

FIG. 12(a) is a graph (measurement results) illustrating respective changes of electric power consumptions in the fixing apparatuses of Example 2-1 and Comparative Example 2. FIG. 12(b) is a graph (measurement results) illustrating respective changes of electric power consumptions in the fixing apparatuses of Example 2-2 and Comparative Example 2. Each of FIG. 13(a) to FIG. 13(c) is a graph (simulation results) illustrating respective changes of the temperatures of the component members of each of the fixing apparatuses of Example 2-1, Example 2-2, and Comparative Example 2.

According to FIG. 12, in Comparative Example 2, the maximum electric power required at the beginning of the sheet passage was 1920 W. In contrast, the maximum electric power required in Example 2-1 was 879 W and the maximum electric power required in Example 2-2 was 892 W. As such, the maximum electric power in each of Examples 2-1 and 2-2 was smaller by approximately 1000 W than that in Comparative Example 1.

Explained here is a reason why the maximum electric power consumption in each of Examples 2-1 and 2-2 was smaller than that in Comparative Example 2, with reference to FIG. 13. In Comparative Example 2, each of the fixing roller and the pressure roller was heated during the standby by the internal heating source, so that heat lost during the standby was only heat radiated from the fixing roller and the pressure roller. As such, heat loss was small. Therefore, even though the elastic layers each having the low thermal conductivity were provided on the surfaces of the fixing roller and the pressure roller, there occurred no large temperature difference in the thickness directions of the rollers. Note that: in Comparative Example 2, the surface temperature of the fixing roller was 175° C. and the temperature of the metal core of the fixing roller was 185° C., whereas the surface temperature of the pressure roller was 140° C. and the temperature of the metal core of the pressure roller was 148° C.

However, once the fixing apparatus was brought from the standby state to the fixing operation state, recording sheets and toner drastically drew heat from the fixing roller and the pressure roller via the fixing nip area. Moreover, the elastic layers coating the fixing roller and the pressure roller had very small heat conductivities. In order to maintain the surface temperatures of the fixing roller and the pressure roller, a large temperature gradient (the roller internal temperature>the roller external temperature) needs to be made. In Comparative Example 2, the surface temperature of the fixing roller was 175° C. and the temperature of the metal core of the fixing roller was 225° C., whereas the surface temperature of pressure roller was 140° C. and the temperature of the metal core of the pressure roller was 158° C. In this way, the inside of each of the rollers needed to be heated such that the temperature thereof was increased rapidly, with the result that electric power consumption was required more.

In contrast, in each of Examples 2-1 and 2-2, the external heating unit supplied heat via the surfaces of the fixing roller and the pressure roller, so that no temperature gradient occurred inside each of the rollers (temperature gradient within 10 deg in each of Examples 2-1 and 2-2). This allowed restraint of the maximum electric power consumption.

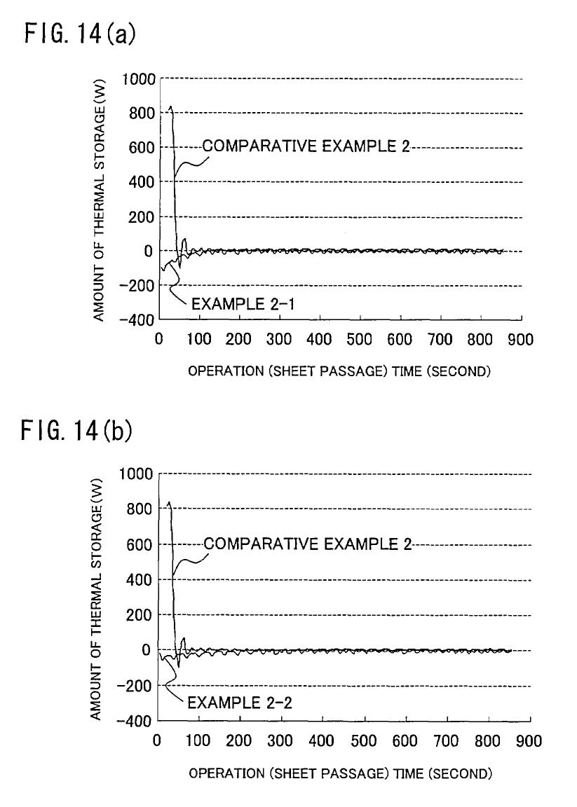

FIG. 14 illustrates results of simulation of finding the amount (thermal storage amount) of heat accumulated in each of the fixing members (fixing roller and pressure roller) per unit of time during the operation state. In FIG. 14, the thermal storage amount is “+” when heat is accumulated in the fixing member, whereas the thermal storage amount is “−” when heat is radiated therefrom. As apparent from the results, in Comparative Example 2, heat was rapidly accumulated in the fixing member at the beginning of the operation state. On the other hand, in each of Examples 2-1 and 2-2, heat was slightly radiated at the beginning of the operation state and then the thermal storage amount became stable around 0.

Table 4 shows results of finding the heat accumulation increment Q1−Q0, the heat capacity Hc, and the average increased temperature (Q1−Q0)/Hc of each of Example 2-1, Example 2-2, and Comparative Example 2 in the same manner in which the heat accumulation increment Q1−Q0, the heat capacity Hc, and the average increased temperature (Q1−Q0)/Hc of each of Example 1-1 Example 1-2, and Comparative Example 1 were found.

TABLE 4

| | | | (Q1 − Q0)/Hc |
|---|---|---|---|
| | Q1 − Q0 (J) | Hc (J/° C.) | (° C.) |
| Example 2-1 | −5518 | 964 | −5.7 |
| Example 2-2 | −6027 | 964 | −6.3 |
| Comparative | 20574 | 964 | 21.3 |
| Example 2 | | | |

According to Table 4, it is found that the thermal storage amount was increased in Comparative Example 2, whereas the thermal storage amounts were slightly decreased in Examples 2-1 and 2-2. Although Example 2-1, Example 2-2, and Comparative Example 2, in each of which the color use fixing apparatus is used, are different from Example 1-1, Example 1-2, and Comparative Example 1, in each of which the monochrome use fixing apparatus is used, an optimum range of the average increased temperature in Examples 2 is found to be substantially the same as that of Examples 1 (See Table 2).

### EXAMPLE 2-3

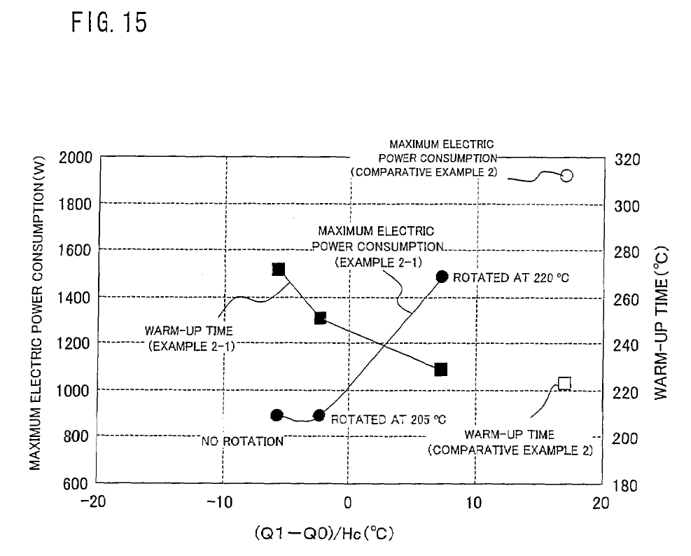

Next, the fixing apparatus 31 used in Example 2-1, which is the actually manufactured fixing apparatus 1 of Embodiment 1, was used in a study for finding (i) a relation between the average increased temperature and the maximum electric power consumption during the passage of sheets (operation), and (ii) a relation between the average increased temperature and the warm-up time. The study was conducted while changing (i) a ratio of electric power to be supplied to the heaters and (ii) rotation timing. The same study was conducted with respect to the fixing apparatus of Comparative Example 2. Table 5 illustrates warm-up conditions and sheet passage conditions. FIG. 15 shows results of the studies. The study was conducted with the use of the fixing apparatus 31 used in Example 2-1, so that Table 5 and FIG. 15 describes the fixing apparatus 31 as “Example 2-1”.

Firstly, with reference to Table 5, the following fully explains the respective warm-up conditions of the fixing apparatuses of Example 2-1 and Comparative Example 2.

TABLE 5

| | | | | | Operation |
|---|---|---|---|---|---|
| | | | | | State |
| | | | Warm-up State | | (Passage |
| | | | Not | | of 1000 |
| | | | Rotated | Rotated | sheets) |
| (1) Example | Rated | Halogen | 190 W | — | 750 W |
| 2-1 | Electric | Heaters A | | | |
| (With No | Power | and B | | | |
| Rotation) | | (External) | | | |
| | | Halogen | 415 W | | 100 W |
| | | Heater C | | | |
| | | (Fixing) | | | |
| | | Halogen | 345 W | | 100 W |
| | | Heater D | | | |
| | | (Pressure) | | | |
| | Controlled | External | 220° C. | | 220° C. |
| | Temperature | Belt | | | |
| | | Fixing | 180° C. | | 180° C. |
| | | Roller | | | |
| | | Pressure | 140° C. | | 140° C. |
| | | Roller | | | |
| (2) Example | Rated | Halogen | 190 W | 950 W | 750 W |
| 2-1 (Rotated | Electric | Heaters A | | | |
| after | Power | and B | | | |
| Temperature | | (External) | | | |
| of External | | Halogen | 415 W | 0 W | 100 W |
| Belt reached | | Heater C | | | |
| 205° C.) | | (Fixing) | | | |
| | | Halogen | 345 W | 0 W | 100 W |
| | | Heater D | | | |
| | | (Pressure) | | | |
| | Controlled | External | 205° C. | 220° C. | 220° C. |
| | Temperature | Belt | | | |
| | | Fixing | (180° C.) | 180° C. | 180° C. |
| | | Roller | | | |
| | | Pressure | (140° C.) | 140° C. | 140° C. |
| | | Roller | | | |
| (3) Example | Rated | Halogen | 950 W | 950 W | 800 W |
| 2-1 (Rotated | Electric | Heaters A | | | |
| after | Power | and B | | | |
| temperature | | (External) | | | |
| of External | | Halogen | 0 W | 0 W | 100 W |
| Belt reached | | Heater C | | | |
| 220° C.) | | (Fixing) | | | |
| | | Halogen | 0 W | 0 W | 600 W |
| | | Heater D | | | |
| | | (Pressure) | | | |
| | Controlled | External | 220° C. | 220° C. | 220° C. |
| | Temperature | Belt | | | |
| | | Fixing | (180° C.) | 180° C. | 180° C. |
| | | Roller | | | |
| | | Pressure | (140° C.) | 140° C. | 140° C. |
| | | Roller | | | |
| (4) | Rated | Halogen | 550 W | — | 1500 W |
| Comparative | Electric | Heater A | | | |
| Example 2 | Power | (Fixing) | | | |
| | | Halogen | 400 W | | 500 W |
| | | Heater B | | | |
| | | (Pressure) | | | |
| | Controlled | Fixing | 175° C. | | 175° C. |
| | Temperature | Roller | | | |
| | | Pressure | 140° C. | | 140° C. |
| | | Roller | | | |

Condition (1): Example 2-1 (With No Rotation)

Condition (1) is a case where the warm-up was carried out with no rotation of the fixing roller and the pressure roller. The controlled temperature (target temperature) that the external heating unit (external heating belt) would have upon the completion of the warm-up was set at 220° C. The controlled temperature that the fixing roller would have thereupon was set at 180° C. The controlled temperature that the pressure roller would have thereupon was set at 140° C. Total electric power usable upon the warm-up was 950 W, and was divided to the external heating unit, the fixing roller, and the pressure roller such that they completed the warm-up at substantially the same time. In this case, electric power supplied to the external heating unit was 190 W, electric power supplied to the fixing roller was 415 W, and electric power supplied to the pressure roller was 345 W. In this case, the fixing roller and the pressure roller were started to rotate, upon start of the passage of sheets.

Condition (2): Example 2-1 (Rotated After Temperature of External Belt Reached 205° C.)

Condition (2) is a case where electric power was divided at the same rate as that in Condition (1) until the temperature of the external heating unit reached 205° C. After the temperature of the external heating unit reached 205° C., all the electric power (950 W) was supplied only to the external heating unit, and the fixing roller and the pressure roller were started to rotate. In this way, the fixing roller and the pressure roller were heated by the heat from the external heating unit.

Condition (3): Example 2-1 (Rotated After Temperature of External Belt Reached 220° C.)

Condition (3) is a case where all the electric power (950 W) had been supplied only to the external heating unit since the beginning of the warm-up and where the fixing roller and the pressure roller were not rotated until the warm-up of the external heating unit was completed (i.e., the temperature of the external heating unit reached 220° C.). After the temperature of the external heating unit reached 220° C., the fixing roller and the pressure roller were rotated while the electric power of 950 W kept on being only supplied to the external heating unit. In this way, the fixing roller and the pressure roller were heated by the heat of the external heating unit.

Condition (4): Comparative Example 2

In Comparative Example 2, no external heating unit is provided, and the fixing roller and the pressure roller include the internal heating sources respectively. Therefore, the warm-up was usually carried out with no rotation of the fixing roller and the pressure roller, as is the case with Condition (1). The controlled temperature (target temperature) that the fixing roller would have upon completion of the warm-up was set at 175° C. The controlled temperature that the pressure roller would have thereupon was set at 140° C. Total electric power usable upon the warm-up was divided and supplied to the fixing roller and the pressure roller. In this case, electric power supplied to the fixing roller was 550 W, and electric power supplied to the pressure roller was 400 W.

Next, FIG. 15 illustrates the results of measuring (i) the relation between the average increased temperature and the maximum electric power consumption during the passage of sheets, and (ii) the relation between the average increased temperature and the warm-up time. The measurement was carried out with the conditions upon the warm-up being changed as shown in Table 5 above. Note that: as soon as the warm-up was completed, each fixing apparatus was brought to the operation (sheet passage) mode and one thousand A4-sized sheets having a basic weight of 60 g were continuously supplied.

According to FIG. 15, it is found that the average increased temperature (Q1−Q0)/Hc was changed by changing (i) the ratio of the electric power during the warm-up and (ii) the rotation timing, and that the maximum electric power consumption was restrained as the average increased temperature was smaller. In other words, in cases where the fixing roller and the pressure roller were heated only by the heat from the external heating unit while rotating the fixing roller and the pressure roller as in Condition (3), only the surfaces of the fixing roller and the pressure roller were heated, with the result that the warm-up was ended even though the internal temperatures of the fixing roller and the pressure roller were not sufficiently raised. Therefore, when the fixing apparatus was thereafter brought to the sheet passage (operation) state, heat was accumulated inside the fixing roller and the pressure roller at the beginning of the sheet passage, with the result that electric power of approximately 1500 W was consumed at maximum. The maximum electric power consumption of approximately 1500 W was still smaller, due to the effect of the external belt, than the maximum electric power consumption (1920 W) in Comparative Example 2. In the meanwhile, consider a case where the warm-up was carried out as in Conditions (1) and (2), i.e., was carried out in such a manner that the fixing roller and the pressure roller were heated from both outside and inside. In this case, the surface temperatures of the fixing roller and the pressure roller were substantially equal to the internal temperatures thereof respectively (in the case of Condition (2)). Otherwise, the internal temperatures of the fixing roller and the pressure roller were higher than the surface temperatures thereof respectively (in the case of Condition (1)). Therefore, even when the fixing apparatus was thereafter brought to the operation (sheet passage) mode, no heat was accumulated in the fixing roller and the pressure roller, with the result that the maximum electric consumption was restrained to be approximately 900 W.

Meanwhile, according to FIG. 15, as the average increased temperature (Q1−Q0)/Hc was smaller, the warm-up time was longer. In other words, in cases where the fixing roller and the pressure roller were not rotated and were heated as in Condition (1), the temperature of the inside of each of the fixing roller and the pressure roller was rather higher (by approximately 20° C.) than each surface temperature of the fixing roller and the pressure roller. As a result, unnecessary heat was accumulated in the fixing members, so that the warm-up time was so long as to be approximately 270 seconds. On the other hand, consider a case where the warm-up was carried out in such a manner that the fixing roller and the pressure roller were heated while being rotated as in Conditions (2) and Condition (3). In this case, the surface temperatures of the fixing roller and the pressure roller were substantially equal to the internal temperatures thereof, respectively (in the case of Condition (2)). Otherwise, the internal temperatures of the fixing roller and the pressure roller were lower than the surface temperatures thereof, respectively (in the case of Condition (3)). Therefore, no unnecessary heat was accumulated in the fixing members, with the result that the warm-up time was shortened to be 250 seconds in the case of Condition (2) and the warm-up time was shortened to be 230 seconds, which is as short as that in the case of Comparative Example 2, in the case of Condition (3).

### Embodiment 3: Monochrome Image Forming Apparatus

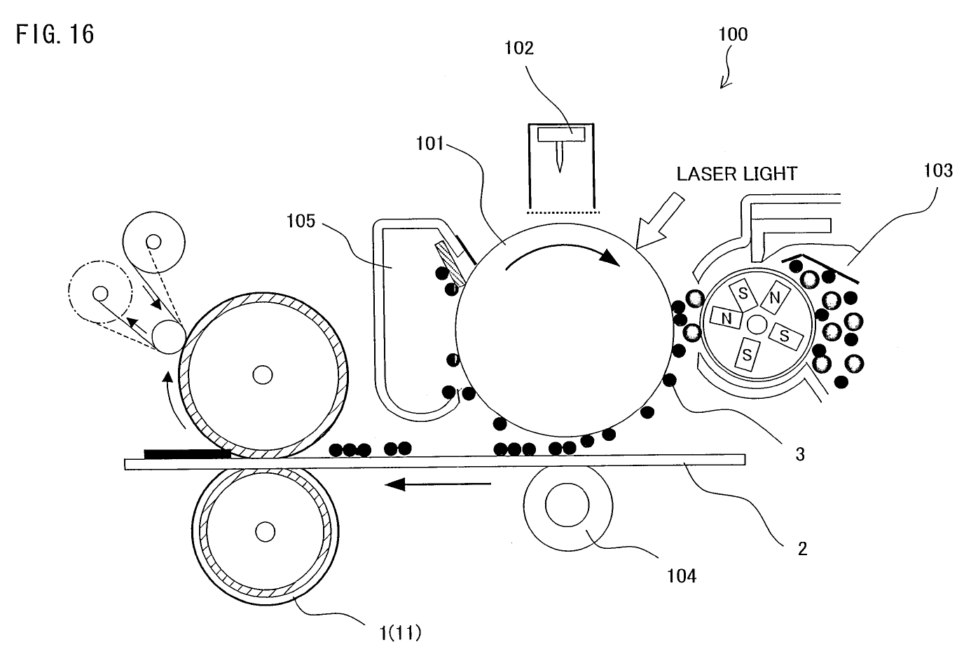

The following explains one embodiment of an image forming apparatus according to the present invention. FIG. 16 is a diagram schematically illustrating an image forming apparatus (copying machine) 100 of the present embodiment. The image forming apparatus includes the fixing apparatus 1 (or 11) described in Embodiments 1. The image forming apparatus 100 of the present embodiment is an electrophotographic type device that carries out printing such that toner adhered to an electrostatic image formed on a photoconductor drum is transferred to a recording sheet.

As shown in FIG. 16, the image forming apparatus 100 includes a photoconductor drum 101; a charging device 102 provided in the vicinity of the photoconductor drum 101; a laser writing unit (not shown); a developing device 103; a transferring device 104; a cleaning device 105; a neutralizing device (not shown); the fixing apparatus 1; an image scanning unit (not shown); a sheet supply unit (not shown) for supplying a recording sheet 2; transporting means (not shown) for transporting the recording sheet 2; and the like.

The charging device 102 charges a surface of the photoconductor drum 101 at a predetermined potential. In the present embodiment, the photoconductor drum 101 is charged by corona discharge.

In accordance with either image data read out by the image scanning unit or image data received from an external device, the laser writing unit irradiates (exposes) laser light to the photoconductor drum 101 so as write an electrostatic latent image on the photoconductor drum 101 with a beam scanning the photoconductor drum 101 that is uniformly charged.

The developing device 103 supplies toner 3 to the electrostatic image formed on the surface of the photoconductor drum 101, so as to visualize the electrostatic latent image. In this way, a toner image is formed.

The transferring device 104 and the photoconductor drum 101 sandwiches the recording sheet 2, with the result that the toner image visualized on the photoconductor drum 101 is transferred (electrostatic-transferred) to the recording sheet 2.

The cleaning device 105 removes and collects toner 3 remaining on the photoconductor drum 101 after the transferring, so that new electrostatic image and toner image can be formed on the photoconductor drum 101. After the cleaning device 105 removes the toner 3, the neutralizing device removes an electric charge from the surface of the photoconductor drum 101.

The fixing apparatus 1 (11) is a device for heating and pressing the toner image having been transferred onto the recording sheet 2, so as to fix the toner image to the recording sheet 2 as described above.

The image forming apparatus 100 having such a structure as described above carries out printing operation in the following manner. Firstly, the image scanning unit scans a document (not shown) so as to obtain image data of the document. The photoconductor drum 101 is rotated at a predetermined speed (here, 400 mm/sec; however, the speed is not limited to this value) in the direction of an arrow shown in FIG. 16, and the charging device 102 charges the surface of the photoconductor drum 101 at a predetermined potential. Next, the laser writing unit exposes, in accordance with the image data of the document scanned by the image scanning unit, the surface of the photoconductor drum 101 so as to write an electrostatic latent image on the surface of the photoconductor drum in accordance with the image data.

Thereafter, the developing device 103 supplies toner 3 to the electrostatic latent image formed on the photoconductor drum 101. The toner 3 is adhered to the electrostatic latent image, thereby forming a toner image. Then, a recording sheet 2 is sandwiched between the photoconductor drum 101 and a transferring roller constituting the transferring device 104, with the result that the toner 3 is transferred to the recording sheet 2. The recording sheet 2 is supplied from the sheet supply unit (not shown).

Thereafter, the fixing apparatus 1 (11) fixes the toner 3 to the recording sheet 2, and the recording sheet 2 is ejected onto a catch unit (not shown). Toner 3 remaining on the photoconductor drum 101 after the transferring is removed and collected by the cleaning device 105.

With this operation, the image forming apparatus 100 carries out printing with respect to the recording sheet 2 appropriately.

### Embodiment 4: Color Image Forming Apparatus

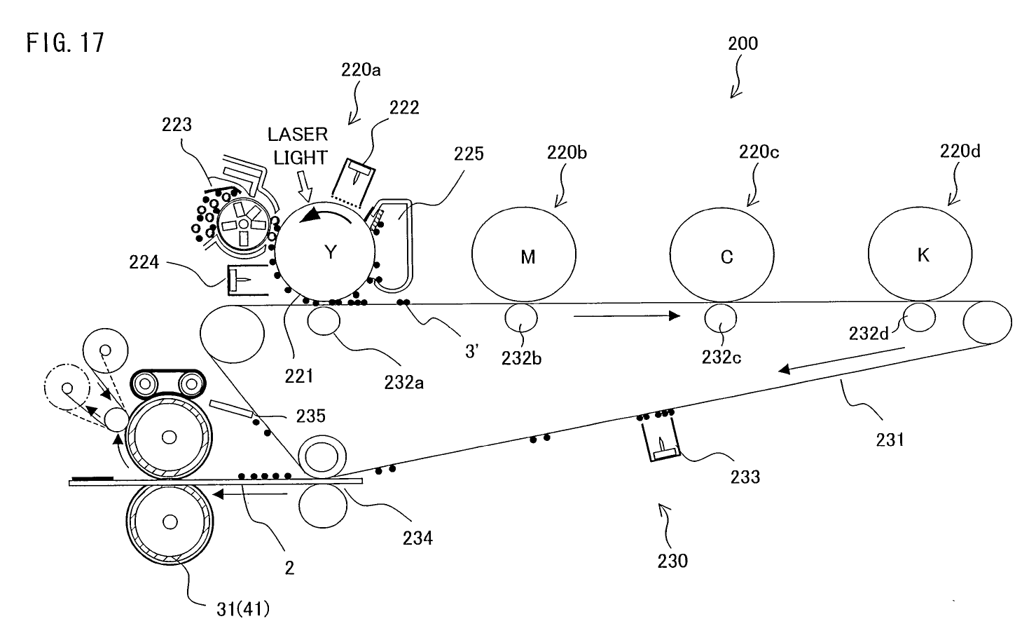

The following explains another embodiment of the image forming apparatus according to the present invention. FIG. 17 is a cross sectional diagram schematically illustrating an image forming apparatus 200 of the present embodiment. The image forming apparatus 200 includes the fixing apparatus 31 (or 41) described in Embodiments 2. The image forming apparatus 200 is a tandem type and intermediate transferring type printer, and is therefore a device that is capable of forming a full color image.

As shown in FIG. 17, the image forming apparatus 200 includes visible image forming units 220a to 220d respectively corresponding to four colors (yellow (Y), magenta (M), cyan (C), and black (K)); a transferring unit 230, and the fixing apparatus 31.

The transferring unit 230 includes: (i) an intermediate transferring belt (image carrier) 231; (ii) four primary transferring devices 232a to 232d provided in the vicinity of the intermediate transferring belt 231; (iii) a secondary pretransfer charging device 233; (iv) a secondary transferring device 234; and (v) a transfer use cleaning device 235.

Color toner images, respectively visualized by the visible image forming units 220a to 220d, are transferred onto the intermediate transferring belt 231 in such a manner that the color toner images overlap with one another. The intermediate transferring belt 231 transfers the transferred image to a recording sheet. The intermediate transferring belt 231 is a belt having a loop shape, is set around a pair of driving rollers and an idling roller, and is controlled to be driven at a predetermined circumferential speed (355 mm/sec in the present embodiment; however, the circumferential speed is not limited to this) for the sake of transporting the color toner images.

The primary transferring device 232a to 232d are provided so as to correspond to the visible image forming units 220a to 220d, respectively. Specifically, the primary transferring device 232a to 232d are respectively provided face to face with the corresponding visible image forming units 220a to 220d with the intermediate transferring belt 231 interposed therebetween. The secondary pretransfer charging device 233 recharges the toner images transferred onto the intermediate transferring belt 231 and overlapping with one another. In the present embodiment, the toner images are charged by corona discharge.

The secondary transferring device 234 transfers, to the recording sheet 2, the toner image having been transferred onto the intermediate transferring belt 231. The secondary transferring device 234 is provided so as to make contact with the intermediate transferring belt 231. The transfer use cleaning device 235 cleans off toner and paper powder each remaining on the surface of the intermediate transferring belt 231 after the transferring of the toner images onto the recording sheet.

The primary transferring devices 232a to 232d, the secondary pretransfer charging device 233, the secondary transferring device 234, and the transfer use cleaning device 235 are provided in this order from the upstream of the transporting direction of the intermediate transfer belt 231, so as to surround the intermediate transferring belt 231 of the transferring unit 230.

In the downstream of the recording sheet transporting direction with respect to the secondary transferring device 234, the fixing apparatus 31 (41) is provided. The fixing apparatus 31 (41) heats and presses the toner images transferred onto the recording sheet 2 by the secondary transferring device 234, so as to fix the toner images onto the recording sheet 2.

Further, the four visible image forming units 220a to 220d are provided in contact with the intermediate transferring belt 231, along the belt in this order in the transporting direction. The four visible image forming units 220a to 220d are identical to one another, except that they use toners 3′ having different colors respectively. Specifically, the four visible image forming units 220a to 220d use yellow (Y) toner 3′, magenta (M) toner 3′, cyan (C) toner 3′, and black (K) toner 3′, respectively. In the following, explanation will be made only for the visible image forming unit 220a, and explanation for the other visible image forming units 220b to 220d will be omitted. For this reason, FIG. 17 only shows the component members of the visible image forming unit 220a; however, each of the other visible image forming units 220b to 220d has the same component members as those of the visible image forming unit 220a.

The visible image forming unit 220a includes a photoconductor drum (image carrier) 221; a latent image charging device 222; a laser writing unit (not shown); a developing device 223; a primary pretransfer charging device 224; a photoconductor use cleaning device 225; and the like. The latent image charging device 222, the laser writing unit, the developing device 223, the primary pretransfer charging device 224, and the photoconductor use cleaning device 225 are provided so as to surround the photoconductor drum 221.

The latent image charging device 222 charges a surface of the photoconductor drum 221 at a predetermined potential. In the present embodiment, the photoconductor drum 221 is charged by corona discharge.

In accordance with either image data read out by the image scanning unit or image data received from an external device, the laser writing unit irradiates (exposes) laser light to the photoconductor drum 221 so as write an electrostatic latent image on the photoconductor drum 221 with a beam scanning the photoconductor drum 101 that is uniformly charged.

The developing device 223 supplies toner 3′ to the electrostatic image formed on the surface of the photoconductor drum 221, so as to visualize the electrostatic latent image. In this way, a toner image is formed. The primary pretransfer charging device 223 recharges the toner image formed on the surface of the photoconductor drum 221. In the present embodiment, the toner image is charged by corona discharge.

The photoconductor use cleaning device 225 removes and collects toner 3′ remaining on the photoconductor drum 221 after transferring the toner image to the intermediate transferring belt 231, so that new electrostatic image and toner image can be formed on the photoconductor drum 221.

Note that: in the visible image forming unit 220a, the latent image charging device 222, the laser writing unit, the developing unit 223, the primary pretransfer charging device 224, the primary transferring device 232a, and the photoconductor use cleaning device 225 are provided in this order from the upstream of the transporting direction of the photoconductor drum 221, so as to surround photoconductor drum 221.

The following explains an image forming operation of the image forming apparatus 200. Firstly, the image forming apparatus 200 acquires image data from an external device. Further, a driving unit (not shown) of the image forming apparatus 200 rotates the photoconductor drum 221 in the direction of an arrow shown in FIG. 17 at a predetermined speed (here, 355 mm/sec; however, the speed is not limited to this), and the latent image charging device 222 charges the surface of the photoconductor drum 221 at a predetermined potential. Next, the laser writing unit exposes the surface of the photoconductor drum 221 in accordance with the acquired image data, so as to write an electrostatic latent image on the surface of the photoconductor drum 221 in accordance with the image data. Thereafter, the developing device 223 supplies toner 3′ to the electrostatic latent image formed on the surface of the photoconductor drum 221, with the result that the toner 3′ is adhered to the electrostatic latent image. In this way, a toner image is formed. Then, the primary transferring device 232a is fed with a bias voltage whose polarity is opposite to the polarity of the toner image formed on the surface of the photoconductor drum 221, with the result that the toner image is transferred to the intermediate transferring belt 231.

The visible image forming units 220a to 220d sequentially carry out the above operation, with the result that toner images respectively having the four colors (Y, M, C, and K) are provided on the intermediate transferring belt 231 so as to overlap with one another. The toner images thus overlapping with one another are transported to the secondary pretransfer charging device 233, and the toner images thus transferred are recharged by the secondary pretransfer charging device 233. Then, the intermediate transferring belt 231 carrying the toner images thus recharged is pressed by the secondary transferring device 234 against a recording sheet 2 supplied from a sheet supply unit (not shown), with the result that the toner images are transferred to the recording sheet 2.

Thereafter, the fixing apparatus 31 (41) fixes the toner images onto the recording sheet 2, and the recording sheet 2 onto which the images have been recorded is ejected to a catch tray (not shown). Toner 3′ remaining on the photoconductor drum 221 after the transferring is removed and collected by the photoconductor use cleaning device 225, whereas toner 3′ remaining on the intermediate transferring belt 231 is removed and collected by the transfer use cleaning device 235.

With the above operation, the image forming apparatus 200 carries out printing with respect to the recording sheet 2 appropriately.

The present invention is not limited to the description of the embodiments above, but may be altered by a skilled person within the scope of the claims. An embodiment based on a proper combination of technical means disclosed in different embodiments is encompassed in the technical scope of the present invention.

For example, in each of Examples described above, the two fixing members, i.e., the fixing roller and the pressure roller are exemplified as the fixing members. However, a plurality of pressure rollers may be provided and each fixing member may have a belt-like shape. Likewise, the belt is exemplified as the external heating means, but the external heating means may have a roller-like shape.

Finally, each of the control circuits 9, 19, 39, and 49 of the fixing apparatuses 1, 11, 31, and 41 of the aforementioned embodiment may be constituted by hardware logic or may be realized by software with the use of a CPU as follows.

That is, each of the fixing apparatuses 1, 11, 31, and 41 includes (i) a CPU (central processing unit) for executing instructions of a control program realizing each function; (ii) a ROM (read only memory) storing the above program; (iii) a RAM (random access memory) for expanding the program; (iv) a storage device (recording medium), such as a memory, storing the program and various types of data; and the like. Therefore, the object of the present invention is achieved by: (i) providing, in each of the fixing apparatuses 1, 11, 31, and 41, a recording medium in which a computer-readable program code (executable program, intermediate code program, a source program) of a control program of each of the fixing apparatus 1, 11, 31, and 41, and (ii) causing a computer (CPU, or MPU) to read out and execute the program code stored in the recording medium.

Examples of the recording medium are: tapes such as a magnetic tape and a cassette tape; magnetic disks such as a floppy® disk and a hard disk; disks such as a CD-ROM (compact disk read only memory), a magnetic optical disk (MO), a mini disk (MD), a digital video disk (DVD), and a CD-Recordable (CD-R); and the like. Further, the recording medium may be: a card such as an IC card or an optical card; or a semiconductor memory such as a mask ROM, an EPROM (electrically programmable read only memory), EEPROM (electrically erasable programmable read only memory), or a flash ROM.

Further, the each of the fixing apparatuses 1, 11, 31, and 41 may be so arranged as to be connectable to a communication network, and the program code may be supplied to the control device via the network. The communication network is not particularly limited. Specific examples thereof are: the Internet, intranet, extranet, LAN (local area network), ISDN (integrated services digital network), VAN (value added network), CATV (cable TV) communication network, virtual private network, telephone network, mobile communication network, satellite communication network, and the like. Further, a transmission medium (channel) constituting the communication network is not particularly limited. Specific examples thereof are: (i) a wired channel using an IEEE1394, a USB (universal serial bus), a power-line communication, a cable TV line, a telephone line, a ADSL line, or the like; or (ii) a wireless channel using IrDA, infrared rays used for a remote controller, Bluetooth®, IEEE802.11, HDR (High Data Rate), a mobile phone network, a satellite connection, a terrestrial digital network, or the like. Note that the present invention can be realized by a form of a computer data signal embedded in a carrier wave realized by electronic transmission of the program code.

As described above, a fixing apparatus according to the present invention includes: a plurality of fixing members for heating and pressing an unfixed image, formed on a recording material, by sandwiching and transporting the recording material; and control means for controlling amounts of heat transfer of the fixing members such that Formula (1), (Q1−Q0)/Hc≦11, is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J /° C.) of the fixing members.

To achieve the object, it is more preferable to arrange the fixing apparatus according to the present invention such that: the control means controls the amounts of the heat transfer of the fixing members such that Formula (2), Q1−Q0/Hc≦0, is satisfied.

The structure of the fixing apparatus according to the present invention allows realization of a fixing apparatus in which the maximum electric power consumption during operation is small and which allows acceleration of processing speed.

Further, in addition to the structure, the fixing apparatus according to the present invention may further include: a plurality of heating means for heating the fixing members, wherein: the control means includes at least one of (a) a temperature control section for controlling set temperatures that the fixing members have during the standby and set temperatures that the fixing members have during the fixing of the unfixed images onto the recording materials; (b) a rotation control section for controlling rotation timing of each of the fixing members; and (c) an electric power supply section for controlling a ratio of electric power to be supplied to the plurality of heating means for heating the fixing members.

According to the above structure, by controlling each of the heating means, it is possible to control the set temperatures that the fixing members have during the standby and the set temperature that the fixing members have during the fixing of the unfixed images, with the result that the amounts of the heat transfer of the fixing members can be controlled. Alternatively, the amounts of the heat transfer of the fixing members can be controlled by controlling the rotation timing of each of the fixing members or controlling the ratio of electric power to be supplied to the heating means for heating the fixing members.

As such, even though no new device is provided, it is possible to control the amounts of the heat transfer of the fixing members with ease by controlling the set temperatures, the rotation timing, and the ratio of electric power.

In cases where the fixing apparatus according to the present invention is arranged such that external heating means is separable from the fixing member(s), the control means may control timing at which the external heating means is separated therefrom. The control over the timing at which the external heating means is separated may be combined with at least one of the controls respectively carried out by (a) the temperature control section, (b) the rotation control section, and (c) the electric power supply section.

Further, the fixing apparatus according to the present invention may be arranged such that: the control means controls the amounts of the heat transfer of the fixing members such that Formula (3), (Q1−Q0)/Hc≧−13, is satisfied.

According to the above structure, the amounts of the heat transfer of the fixing members is restrained such that Formula (3) is satisfied. By carrying out control in this way, it is possible for the fixing apparatus to keep on carrying out fixing stably for a long time.

In addition to the above structure, the fixing apparatus according to the present invention may be arranged such that: as one of the heating means, a heating source is provided in a fixing member, making contact with each recording material so as to meet a surface on which no image is formed, of the fixing members.

According to the above structure, the heating source is provided inside the fixing member making contact with the recording material so as to meet the surface on which no image is formed, thereby preheating, during the standby, the fixing member making contact with the recording material so as to meet the surface on which no image is formed. This makes it possible to restrain heat loss due to accumulation of heat in the fixing member making contact with the recording material so as to meet the surface on which no image is formed, when the fixing apparatus is brought into the operation state.

Further, in addition to the above structure, the fixing apparatus according to the present invention may be arranged such that: the control means carries out control such that the heating source provided in the fixing member making contact with each recording material so as to meet a surface on which no image is formed supplies heat only during either the standby or the warm-up.

According to the above structure, the control is carried out such that heat is supplied only during either the standby or the warm-up from the heating source provided in the fixing member making contact with the recording material so as to meet the surface on which no image is formed. Therefore, the heating source provided in the fixing member making contact with the recording material so as to meet the surface on which no image is formed is used only during the standby, so that the electric consumption during the operation can be restrained. This reduces the maximum electric power consumption in the entire device.

Further, in addition to the above structure, the fixing apparatus according to the present invention may be arranged such that: as one of the heating means, a heating source is provided outside at least any one of the fixing members so as to heat the fixing member. According to this structure, the fixing member is heated externally by the heating source provided outside the fixing member. In addition to this structure, the fixing apparatus according to the present invention may be arranged such that: the fixing member heated by the heating source provided outside the fixing member is provided with a metal core and an elastic layer having a thermal conductivity smaller than a thermal conductivity of the metal core. According to this structure, in cases where the fixing member heated externally by the heating source provided outside the fixing member has such an elastic layer (made of silicone rubber or the like) having a thermal conductivity smaller than that of the metal of which the metal core of the fixing member is made, the heating of the fixing member from outside makes it possible to restrain heat from accumulating inside the fixing member due to temperature increase.

In addition to the above structure, the fixing apparatus according to the present invention may be arranged such that: as the heating means, a heating source is provided in the fixing member heated by the heating source provided outside the fixing member.

According to the above structure, the heating source is provided in the fixing member heated by the heating source provided outside the fixing member, so that the fixing member is heated from inside. Such a heating source provided therein is suitably used for preheating. Note that the external heating means is only capable of heating a part of the fixing member and is therefore unsuitable for preheating.

Further, in addition to the above structure, the fixing apparatus according to the present invention may be arranged such that: the control means carries out control such that the heating source provided in the fixing member heated by the heating source provided outside the fixing member radiates heat during the standby, and such that the heating source provided outside the fixing member radiates heat while the fixing apparatus carries out the operation of fixing the unfixed images onto the recording materials. Such control allows the following effect.

That is, according to the above structure, the heating source provided in the fixing member radiates heat during the standby, whereas the heating source provided outside the fixing member radiates heat during the operation of fixing the unfixed images onto the recording materials. As such, the internal heating source, which is capable of heating the entire the fixing member, is used during the standby and the external heating source, which never causes accumulation of heat inside the fixing member, is used during the operation, with the result that accumulation of heat during the operation can be restrained as much as possible. This reduces electric power consumption, with the result that the operation can be carried out efficiently.

In addition to the above structure, the fixing apparatus according to the present invention may be arranged such that: the operation of fixing the unfixed images onto the recording materials is carried out at a processing speed of 300 mm/sec or faster.

Usually, the operation of fixing the unfixed images onto the recording materials is carried out at a processing speed of 300 mm/sec or faster in a fast copying machine in which electric consumption is large. In cases where the fixing apparatus according to the present invention is provided in such a fast copying machine in which electric consumption is large, a good effect is especially exhibited. Specifically, the maximum electric consumption is reduced and the processing is accelerated.

To achieve the object, an image forming apparatus according to the present invention includes any one of the fixing apparatuses described above. Also in this case, it is possible to attain effects substantially identical to the effects described above.

To achieve the object, a method according to the present invention for controlling a fixing apparatus including a plurality of fixing members for heating and pressing an unfixed image, formed on a recording material, by sandwiching and transporting the recording material includes the step of: controlling amounts of heat transfer of the fixing members such that Formula (1), (Q1−Q0)/Hc≦11, is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

Further, to achieve the object, it is more preferable that the method according to the present invention for controlling the fixing apparatus include the step of controlling amounts of heat transfer of the fixing members such that Formula (2), (Q1−Q0)/Hc≦0, is satisfied.

Also in these cases, it is possible to attain effects substantially identical to the effects described above.

The method for controlling the fixing apparatus may be realized by a computer. In this case, the present invention encompasses (i) a fixing apparatus control program for causing a computer to carry out the aforementioned control, and (ii) a computer-readable recording medium storing the control program.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

Finally, the fixing apparatus, the fixing method control method, and the like of the present invention are applicable to an electrophotographic image forming apparatus such as a printer, a copying machine, a facsimile, or an MFP (Multi Function Printer).

What is claimed is:

1. A fixing apparatus, comprising:
a plurality of fixing members for heating and pressing an unfixed image, formed on a recording material, by sandwiching and transporting the recording material; and
control means for controlling amounts of heat transfer of the fixing members such that Formula (1), (Q1−Q0)/Hc≦11, is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

2. A fixing apparatus, comprising:
a plurality of fixing members for heating and pressing an unfixed image, formed on a recording material, by sandwiching and transporting the recording material; and
control means for controlling amounts of heat transfer of the fixing members such that Formula (2), (Q1−Q0)/Hc≦0 is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

3. The fixing apparatus as set forth in claim 1, further comprising:
a plurality of heating means for heating the fixing members,
wherein:
said control means includes at least one of (a) a temperature control section for controlling set temperatures that the fixing members have during the standby and set temperatures that the fixing members have during the fixing of the unfixed images onto the recording materials; (b) a rotation control section for controlling rotation timing of each of the fixing members; and (c) an electric power supply section for controlling a ratio of electric power to be supplied to the plurality of heating means for heating the fixing members.

4. The fixing apparatus as set forth in claim 1, wherein:
said control means controls the amounts of the heat transfer of the fixing members such that Formula (3), (Q1−Q0)/Hc≦−13, is satisfied.

5. The fixing apparatus as set forth in claim 3, wherein:
as one of the heating means, a heating source is provided in a fixing member, making contact with each recording material so as to meet a surface on which no image is formed, of the fixing members.

6. The fixing apparatus as set forth in claim 5, wherein:
said control means carries out control such that the heating source provided in the fixing member making contact with each recording material so as to meet a surface on which no image is formed supplies heat only during either the standby or the warm-up.

7. The fixing apparatus as set forth in claim 3, wherein:
as one of the heating means, a heating source is provided outside at least any one of the fixing members so as to heat the fixing member.

8. The fixing apparatus as set forth in claim 7, wherein:
the fixing member heated by the heating source provided outside the fixing member is provided with a metal core and an elastic layer having a thermal conductivity smaller than a thermal conductivity of the metal core.

9. The fixing apparatus as set forth in claim 7, wherein:
as one of the heating means, a heating source is provided in the fixing member heated by the heating source provided outside the fixing member.

10. The fixing apparatus as set forth in claim 9, wherein:
said control means carries out control such that the heating source provided in the fixing member heated by the heating source provided outside the fixing member radiates heat during the standby, and such that the heating source provided outside the fixing member radiates heat while the fixing apparatus carries out the operation of fixing the unfixed images onto the recording materials.

11. The fixing apparatus as set forth in claim 1, wherein:
the operation of fixing the unfixed images onto the recording materials is carried out at a processing speed of 300 mm/sec or faster.

12. The fixing apparatus as set forth in claim 3, wherein:
the fixing members consist of a fixing roller and a pressure roller, the fixing roller and the pressure roller each having the heating means therein, and
temperature detecting means for detecting respective temperatures of the fixing roller and the pressure roller is provided.

13. A image forming apparatus, comprising a fixing apparatus,
said fixing apparatus including:
a plurality of fixing members for heating and pressing an unfixed image, formed on a recording material, by sandwiching and transporting the recording material; and
control means for controlling amounts of heat transfer of the fixing members such that Formula (1), (Q1−Q0)/Hc≦11, is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

14. A method for controlling a fixing apparatus including a plurality of fixing members for heating and pressing an unfixed image, formed on a recording material, by sandwiching and transporting the recording material,
said method, comprising the step of:
controlling amounts of heat transfer of the fixing members such that Formula (1), (Q1−Q0)/Hc≦11 is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

15. A method for controlling a fixing apparatus including a plurality of fixing members for heating and pressing an unfixed image, formed on a recording material, by sandwiching and transporting the recording material,
said method, comprising the step of:
controlling amounts of heat transfer of the fixing members such that Formula (2), (Q1−Q0)/Hc≦0 is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

16. A control program for realizing, in a computer, a method for controlling a fixing apparatus including a plurality of fixing members for heating and pressing an unfixed image, formed on a recording material, by sandwiching and transporting the recording material,
said control program causing the computer to control amounts of heat transfer of the fixing members such that Formula (1), (Q1−Q0)/Hc≦11, is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.

17. A computer-readable recording medium storing a control program for realizing, in a computer, a method for controlling a fixing apparatus including a plurality of fixing members for heating and pressing an unfixed image, formed on a recording material, by sandwiching and transporting the recording material,
said control program causing the computer to control amounts of heat transfer of the fixing members such that Formula (1), (Q1−Q0)/Hc≦11, is satisfied where Q0 represents total amounts (J) of heat that the fixing members have during standby or just after completion of warm-up, Q1 represents total amounts (J) of heat that the fixing members have and that are saturated as a result of continuously fixing unfixed images onto recording materials, and Hc represents a heat capacity (J/° C.) of the fixing members.
